(19) United States
(12) Patent Application Publication
(10) Pub. No.: US 2023/0242030 A1
(43) Pub. Date: Aug. 3, 2023

(54) TRANSPORTABLE SLURRY BOX SYSTEM

(71) Applicant: MagTec Alaska, LLC, Kenai, AK (US)

(72) Inventor: Ryan A Peterkin, Nikiski, AK (US)

(21) Appl. No.: 18/295,221

(22) Filed: Apr. 3, 2023

Related U.S. Application Data
(63) Continuation-in-part of application No. 18/165,815, filed on Feb. 7, 2023.
Application No. 18/165,815 is a continuation of application No. 17/186,208, filed on Feb. 26, 2021, now Pat. No. 11,618,367.
Application No. 17/186,208 is a continuation of application No. 17/061,946, filed on Oct. 2, 2020, now Pat. No. 10,933,794.
Application No. 17/061,946 is a continuation-in-part of application No. 18/170,206, filed on Feb. 16, 2023.
Application No. 18/170,206 is a continuation of application No. 17/838,508, filed on Jun. 13, 2022.
Application No. 17/838,508 is a continuation of application No. 17/833,137, filed on Jun. 6, 2022.
Application No. 17/833,137 is a continuation-in-part of application No. 17/579,792, filed on Jan. 20, 2022, now Pat. No. 11,396,419.
Application No. 17/579,792 is a continuation-in-part of application No. 17/396,403, filed on Aug. 6, 2021.

(51) Int. Cl. B60P 3/22; B65D 81/38; B65D 88/74; B65D 81/20

(52) U.S. Cl. CPC B60P 3/2295; B60P 3/2205; B60P 3/226; B65D 81/3813; B65D 88/748; B65D 81/2015; B65D 88/744

(57) ABSTRACT

A transportable slurry box includes a structure comprising an interior to contain a cuttings slurry; a door movable between a closed position and an open position to provide access to the interior of the structure, wherein the door is located within a top surface of the transportable slurry box; a mechanical bay in the structure; and a heating unit removably mounted within the mechanical bay of the transportable slurry box for heating the cuttings slurry within the interior.

### CROSS-REFERENCE TO RELATED APPLICATIONS

This application claims the priority as a continuation-in-part of U.S. Nonprovisional patent application Ser. No. 18/165,815 (01734-PET) filed Feb. 7, 2023 which is a continuation of U.S. Nonprovisional patent application Ser. No. 17/186,208 (01590-PET) filed Feb. 26, 2021 which issues as U.S. Pat. No. 11,618,367 on Apr. 4, 2023 and is a continuation of U.S. Nonprovisional patent application Ser. No. 17/061,946 (01686-PET) filed Oct. 2, 2020 which issued as U.S. Pat. No. 10,933,794 on Mar. 2, 2021.

This application claims the priority as a continuation-in-part of U.S. Nonprovisional patent application Ser. No. 18/170,206 (01781-PET) filed Feb. 16, 2023 which is a continuation of U.S. Nonprovisional patent application Ser. No. 17/838,508 (01690-PET) filed Jun. 13, 2022 which is a continuation of U.S. Nonprovisional patent application Ser. No. 17/833,137 (01689-PET) filed Jun. 6, 2022 which is a continuation-in-part of U.S. Nonprovisional patent application Ser. No. 17/579,792 (01493P02-PET) filed Jan. 20, 2022 which issued as U.S. Pat. No. 11,396,419 on Jul. 26, 2022 and is a continuation-in-part of U.S. Nonprovisional patent application Ser. No. 17/531,989 (01450-PET) filed Nov. 22, 2021 which is a continuation-in-part of U.S. Nonprovisional patent application Ser. No. 17/396,403 (01393-PET) filed Aug. 6, 2021.

Each of the aforementioned patent applications, and any applications related thereto, are herein incorporated by reference in their entirety.

### FIELD OF TECHNOLOGY

This disclosure relates generally to technology for roll-off self-contained cutting boxes for heated slurry transport, receiving, and dumping in cold climates with freezing temperatures.

### BACKGROUND

Drill cuttings are produced during drilling of oil wells and gas wells. The drill cuttings are carried to the surface by a drilling fluid circulating up from the drill bit. The drill cuttings are separated from the drilling fluid so the recycled drilling fluid may be reused during the drilling process. The separated drill cuttings along with a portion of the drilling fluid and other fluids form a cuttings slurry that is often transported to a tank for holding until full. Once the tank is full of the cuttings slurry, the cuttings slurry is transported to a disposal facility.

One problem with conventionally transporting cuttings slurry in a tank is that the cuttings slurry may freeze in cold weather environments such as Alaska, cold climate states and Canada, making it difficult to unload the cuttings slurry from the vacuum box. To solve this problem one solution is to provide heat energy to keep the cuttings slurry from freezing.

Vacuum tanks must be removed from oil and gas well sites in a timely manner such to not impede the function of a drilling rig at an oil or gas well site. Such sites are limited in space and storing many vacuum tanks on the oil or gas well site is not possible with current tank systems. Further portable slurry boxes often do not fit the requirements to be efficiently emptied at disposal facilities. In the warm summer months, poor road conditions cause excess wear on equipment. Transporting vacuum tanks with heating functions over summer roads during times of the year when the heating functions are unneeded unnecessarily causes wear on such equipment.

### SUMMARY

A transportable slurry box according to one disclosed non-limiting embodiment of the present disclosure includes a structure comprising an interior to contain a cuttings slurry; a door movable between a closed position and an open position to provide access to the interior of the structure, wherein the door is located within a top surface of the transportable slurry box; a mechanical bay in the structure; and a heating unit removably mounted within the mechanical bay of the transportable slurry box for heating the cuttings slurry within the interior.

A further embodiment of any of the foregoing embodiments of the present disclosure includes, wherein the structure at least partially forms a tank that defines the interior to contain the cuttings slurry.

A further embodiment of any of the foregoing embodiments of the present disclosure includes, wherein the structure can withstand a vacuum pressure.

A further embodiment of any of the foregoing embodiments of the present disclosure includes a tailgate movable between an open position in which the tailgate opens upward toward a top of the transportable slurry box and a closed position which seals the transportable slurry box; a tailgate hinge that defines a hinge axis parallel to the top of the transportable slurry box; a first hydraulic mount affixed to the transportable slurry box, the hydraulic mount located between the hinge axis and the top of the transportable slurry box; a second hydraulic mount affixed to the tailgate; and a hydraulic actuator cylinder mounted to the first hydraulic mount and the second hydraulic mount, the hydraulic cylinder transverse the axis.

A further embodiment of any of the foregoing embodiments of the present disclosure includes a hydraulic pump driven by a power unit within the mechanical bay, the hydraulic pump contained in the mechanical bay, wherein the hydraulic pump produces flow and pressure to operate the hydraulic cylinder to move the tailgate between the open position and the closed position.

A further embodiment of any of the foregoing embodiments of the present disclosure includes that the heating unit is removably mounted within the mechanical bay of the transportable slurry box.

A further embodiment of any of the foregoing embodiments of the present disclosure includes that the heating unit includes a supply port and a return port, and wherein the heating unit is adapted to heat a fluid producing a heated fluid flow; and a first heat loop fluidly connected to the supply port of the heating unit and the return port of the heating unit, wherein the first heat loop is attached to the interior, and wherein the first heat loop circulates the heated fluid flow to heat the interior, wherein the first heat loop comprises a first supply line fluidly connected to the supply port and a first return line fluidly connected to the return port, the first supply line and the first return line each have a straight structure that is parallel with respect to a longitudinal axis of the structure of the transportable slurry box.

A further embodiment of any of the foregoing embodiments of the present disclosure includes that the heating unit comprises an electrically powered heating unit.

A further embodiment of any of the foregoing embodiments of the present disclosure includes a hook point on the structure to receive a wire break safety stop.

A further embodiment of any of the foregoing embodiments of the present disclosure includes that a roll off rail hardened strip manufactured of abrasion resistant steel armor plate along at least a portion of a bottom of the structure.

A tailgate assembly for a transportable slurry box according to one disclosed non-limiting embodiment of the present disclosure includes a tailgate movable between an open position in which the tailgate opens upward toward a top of a structure of the transportable slurry box and a closed position which seals the transportable slurry box; a tailgate hinge that defines a hinge axis parallel to the top of the structure of the transportable slurry box; a first hydraulic mount affixed to the structure of the transportable slurry box, the first hydraulic mount defines a first hydraulic mount axis located between the hinge axis and the top of the structure of the transportable slurry box; a second hydraulic mount affixed to the tailgate, the second hydraulic mount defines a second hydraulic mount axis displaced from the tailgate; and a hydraulic actuator cylinder mounted to the first hydraulic mount and the second hydraulic mount, the hydraulic cylinder transverse the hinge axis.

A further embodiment of any of the foregoing embodiments of the present disclosure includes that the first hydraulic mount axis is displaced from the structure of the transportable slurry box a distance greater than that which the hinge axis is displaced from the structure of the transportable slurry box.

A further embodiment of any of the foregoing embodiments of the present disclosure includes that the first hydraulic mount axis and the second hydraulic mount axis are parallel to the hinge axis.

A further embodiment of any of the foregoing embodiments of the present disclosure includes that a hydraulic powered vertical latch adjacent to a bottom of the tailgate.

A further embodiment of any of the foregoing embodiments of the present disclosure includes that a manual lock adjacent to a side of the tailgate.

A further embodiment of any of the foregoing embodiments of the present disclosure includes that the manual lock comprises a threaded fastener attached to the tailgate engageable with a bracket on the structure of the transportable slurry box.

A further embodiment of any of the foregoing embodiments of the present disclosure includes that a safety brace hingedly attached to the tailgate, the safety brace configured such that the tailgate may not close when the safety brace is positioned against a pin that extends from the structure of the transportable slurry box.

A further embodiment of any of the foregoing embodiments of the present disclosure includes that the safety brace is hingedly attached to the tailgate adjacent to the second hydraulic mount affixed to the tailgate.

A transportable slurry box according to one disclosed non-limiting embodiment of the present disclosure includes a structure comprising an interior to contain a cuttings slurry; a door movable between a closed position and an open position to provide access to the interior of the structure, wherein the door is located within a top surface of the transportable slurry box to receive the cuttings slurry; a tailgate movable between an open position in which the tailgate opens upward toward a top of a structure of the transportable slurry box and a closed position which seals the transportable slurry box; a tailgate hinge that defines a hinge axis parallel to the top of the structure of the transportable slurry box; a first hydraulic mount affixed to the structure of the transportable slurry box, the first hydraulic mount defines a first hydraulic mount axis located between the hinge axis and the top of the structure of the transportable slurry box; a second hydraulic mount affixed to the tailgate, the second hydraulic mount defines a second hydraulic mount axis displaced from the tailgate; and a hydraulic actuator cylinder mounted to the first hydraulic mount and the second hydraulic mount, the hydraulic cylinder transverse the hinge axis.

A further embodiment of any of the foregoing embodiments of the present disclosure includes a mechanical bay in the structure; a hydraulic pump driven by a power unit within the mechanical bay of the transportable slurry box, the hydraulic pump contained in the mechanical bay, wherein the hydraulic pump produces flow and pressure to operate the hydraulic cylinder to move the tailgate between the open position and the closed position; and a heating unit removably mounted within the mechanical bay of the transportable slurry box for heating the cuttings slurry within the interior.

The foregoing features and elements may be combined in various combinations without exclusivity, unless expressly indicated otherwise. These features and elements as well as the operation thereof will become more apparent in light of the following description and the accompanying drawings. It should be appreciated that however the following description and drawings are intended to be exemplary in nature and non-limiting.

### BRIEF DESCRIPTION OF THE DRAWINGS

Various features will become apparent to those skilled in the art from the following detailed description of the disclosed non-limiting embodiment. The drawings that accompany the detailed description can be briefly described as follows:

FIG. 1 is a perspective view of an exemplary transportable slurry box.

FIG. 2 is a perspective view of an exemplary transportable slurry box mounted on a vehicle.

FIG. 3 is a perspective view of an exemplary transportable slurry box displaced from a vehicle.

FIG. 4 is a top view of an exemplary transportable slurry box.

FIG. 5 is a driver-side view of an exemplary transportable slurry box.

FIG. 6 is a front view of an exemplary transportable slurry box.

FIG. 7 is a rear view of an exemplary transportable slurry box.

FIG. 8 is an exploded view showing how the power unit can be removed.

FIG. 9 is a perspective view of an exemplary transportable slurry box showing the tailgate in the open position.

FIG. 10 is a sectional view of an exemplary jacketed flange.

FIG. 11 is a schematic view of an exemplary set of warming tubes.

FIG. 12 is a simplified block diagram showing a method in which a transportable slurry box is used efficiently according to one disclosed non-limiting embodiment.

FIG. 13 is a schematic view of an exemplary transportable slurry box connected at an oil rig.

FIG. 14 is a perspective view of two slurry boxes stacked on top of each other.

FIG. 15 is a simplified block diagram showing a method in which a transportable slurry box is unloaded according to one disclosed non-limiting embodiment.

FIG. 16 is a side view of an exemplary transportable slurry box in a raised position on a vehicle.

FIG. 17A is a view of a wire break safety stop.

FIG. 17B is a view of the wire break safety stop installed to secure the transportable slurry box secured to the vehicle in a raised position

FIG. 18 is a perspective view of a transportable slurry box according to another disclosed non-limiting embodiment.

FIG. 19 is a perspective view of the transportable slurry box of FIG. 18 with a door within a top surface and a tailgate in an open position.

FIG. 20 is a bottom view of the transportable slurry box of FIG. 18.

FIG. 21 is a side view of the transportable slurry box of FIG. 18 with the door within a top surface and the tailgate in an open position.

FIG. 22 is a partial view of the transportable slurry box of FIG. 18 with the tailgate in a closed position.

FIG. 23 is an expanded view of the tailgate in a closed position.

FIG. 24 is an expanded side view of the tailgate in an open position.

### DETAILED DESCRIPTION

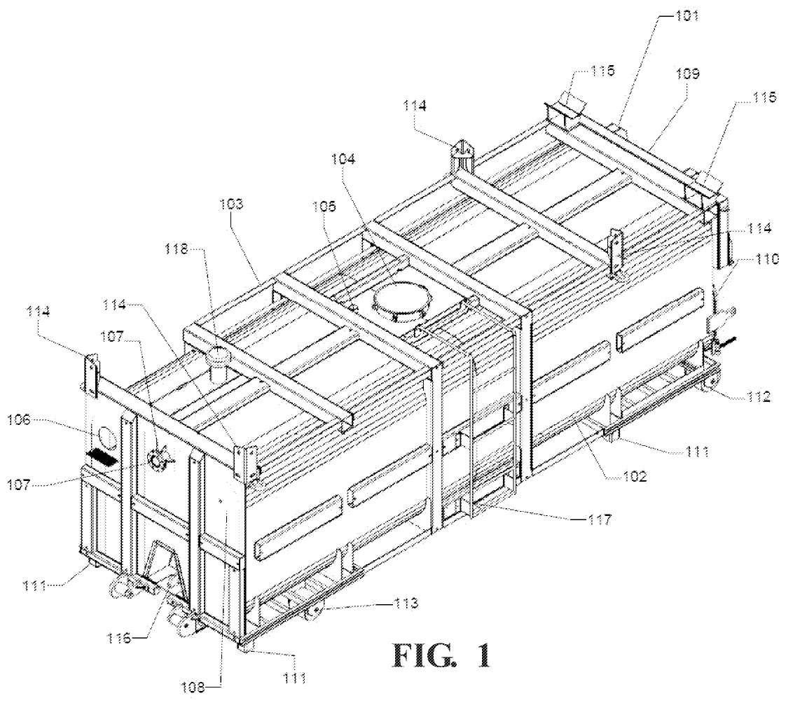

FIG. 1 is a perspective view of a transportable slurry box 101 according to one embodiment. The transportable slurry box 101 generally includes a tank 102, a structure 103, and a mechanical bay 106. The transportable slurry box 101 has a front 108 and a rear 109. The tank 102 may be mounted at least partially within the structure 103. Attached to the tank 102 is a manhole 104 which can be opened to allow for a person to enter the tank 102 or to load or unload the tank 102. The tank 102, in various embodiments, can withstand full or partial vacuum pressure. When the tank 102 is placed under a vacuum from an external vacuum pump, material may be drawn into the tank 102. Mounted on the tank 102 is a thermo relief valve 105. Fluidly attached to the tank 102 may be one or more openings for loading and unloading. Each opening may be closed to fluidly seal the tank 102.

Fluidly attached to the tank 102 may be one or more openings for loading and unloading. Each opening may be closed to fluidly seal the tank 102. In the disclosed tank 102, a front pipe port 107 may be utilized. The front pipe port 107 can be used either for loading or unloading depending on requirements dictated by the worksite at which the transportable slurry box 101 is located. A vacuum pump may be fluidly attached to the front pipe port 107 or any other pipe port on the transportable slurry box 101. The extent of the vacuum to be applied within the tank 102 may range from relative atmospheric pressure to a full vacuum depending on the application at a worksite. In the event the front pipe port 107 is not being utilized at a job site, the front pipe port 107 may be covered or may be connected to a valve which seals the opening. Any opening on the tank 102, including the front pipe port 107, may be jacketed with an exterior surface to allow a heat fluid flow to be circulated around an inner surface. In one example, the front pipe port 107 may have a five-inch inner surface through which material may be loaded or unloaded to the tank 102 and a six-inch exterior surface.

At the rear 109 of the transportable slurry box 101, a tailgate 110 can be provided. The tailgate 110 is attached to hinges on the transportable slurry box 101 which allows the tailgate 110 to be mechanically opened vertically. In many applications, the transportable slurry box 101 needs to be unloaded at sites which do not allow for excess lateral space around the transportable slurry box 101. By attaching the tailgate 110 on the transportable slurry box 101 such that it is vertically openable, the transportable slurry box 101 does not require additional lateral space to either side. When closed, the tailgate 110 is sealed to the tank 102 such that the tank 102 may maintain vacuum pressure.

The structure 103 of the transportable slurry box 101 may be arranged to at least partially contain the tank 102. Alternately, the structure 103 may form the tank 102. The structure 103 may include a ladder to facilitate access to the manhole 104 at the top of the transportable slurry box 101. The structure 103 allows for the transportable slurry box 101 to be lifted, moved, or transported. At the bottom of the transportable slurry box 101 a rear wheel set 112 is attached to the structure 103 near the rear 109. The rear wheel set 112 is as commonly appreciated for use in roll-off containers. In the embodiment shown in FIG. 1 an optional front wheel set 113 is also provided. The rear wheel set 112 and the optional front wheel set 113 as included in some embodiments comprise a base wheel set.

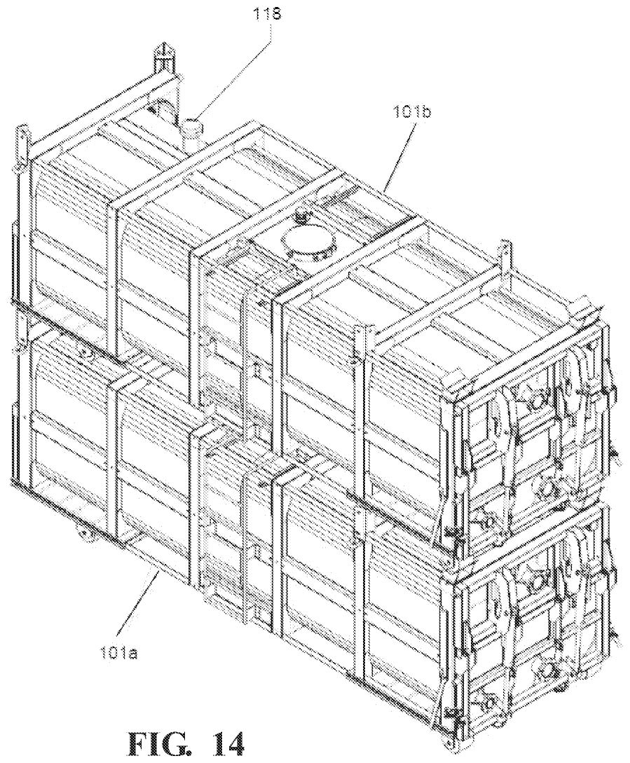

The structure 103 permits the transportable slurry box 101 to be stacked vertically (FIG. 14). Many gas or oil well sites have limited space on which equipment can be placed and the ability to stack the transportable slurry box 101 is a valuable function. To facilitate the stacking function, attached to the structure 103 is at least one stacking leg 111 and at least one stacking mount 114. In an exemplary embodiment, four stacking mounts and four stacking legs are provided. A rear wheel platform 115 may be attached to the structure 103 to support a wheel set when a transportable slurry box 101 is stacked. In this embodiment, a set of rear wheel platforms are demonstrated in a position that would support the rear wheel set 112 when stacked. The transportable slurry box 101 may be lifted using d-rings and chains, a forklift, or any other lifting mechanism. When stacked each respective stacking leg 111 fits into each respective stacking mount 114. The one or more stacking mounts collectively form a stacking mount system. The one or more stacking legs form a stacking leg system. The stacking leg systems fits together with the stacking mount system.

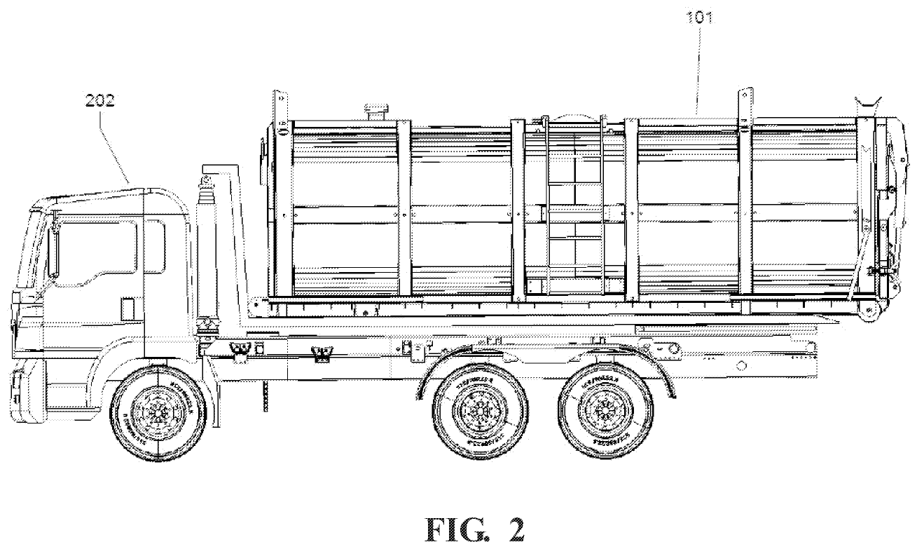

In the disclosed embodiment, the transportable slurry box 101 may be a roll-off container. A roll-off container is a portable container which may be transported on a vehicle 202 (FIG. 2). The transportable slurry box 101 may be, for example, a cable type roll-off container. A cable roll-off container may be pulled or placed on a vehicle such as a tilt-bed vehicle such as a truck or trailer by a winch.

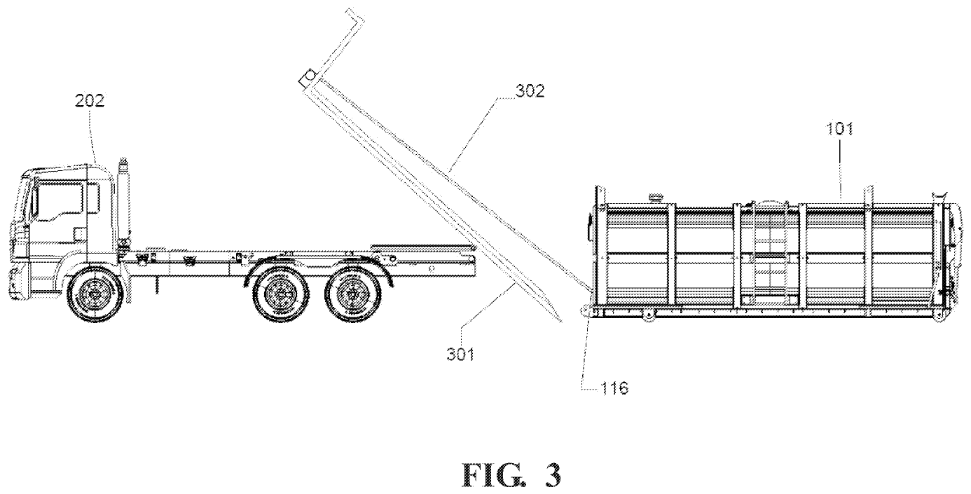

A cable 302 (FIG. 3) driven by the winch may be attached to a hook point 116 on the structure 103. The transportable slurry box 101 may be then pulled onto the vehicle. In an alternative embodiment, the structure 103 may be built to allow for the hook point 116 to be attached near the top of the structure 103 to allow for a hook-loader type vehicle to pull the transportable slurry box 101 onto the vehicle. For the purpose of this disclosure, a roll-off vehicle is considered to be either a tilt-bed vehicle, a truck trailer combination, or a hook-loader type vehicle. A truck trailer combination type vehicle is a vehicle 202 where a truck pulls a trailer, the trailer which is a hook-loader type trailer or a tilt-bed type trailer. In a truck trailer combination, the transportable slurry box 101 is pulled onto the trailer section of the truck trailer combination just as a transportable slurry box 101 is pulled onto a tilt-bed vehicle or a hook-loader type vehicle.

The transportable slurry box 101 may be sized to fit on a vehicle. The transportable slurry box 101 may be built in a variety of sizes and shapes to for different vehicles. An exemplary transportable slurry box 101 may be 2.26 meters (89 inches) wide by 7.37 meters (290 inches) long. A transportable slurry box 101 with such dimensions would be compliant with certain various jurisdictional transportation requirements.

A mechanical bay 106 may be included in the transportable slurry box 101. In the mechanical bay 106 certain ancillary equipment is located such as an example power unit 801 for providing heat energy to fluid within warming tubes and jacketed openings. The power unit 801 is adapted to provide heat energy to fluid within the system of warming tubes and jacketed openings. The system of warming tubes and jacketed openings receive a heating fluid which is provided heat from the power unit by the use of a heat exchanger or other system. The fluid is circulated through the system of warming tubes and jacketed openings to distribute the heat energy. The fluid being circulated is a heated fluid flow. The power unit 801 may also provide energy to power a hydraulic pump to produce flow and pressure to operate various hydraulic functions. Such hydraulic functions include but are not limited to hydraulically opening the vertical tailgate. The power unit 801 may include a diesel engine with a fuel tank, an electric motor with a battery bank, or such. The power unit may also provide energy to power a hydraulic pump to produce flow and pressure to operate various hydraulic functions. Such hydraulic functions include but are not limited to hydraulically opening the tailgate 110. The mechanical bay 106 may be designed to allow for the power unit to be disconnected and removed when not needed. An exhaust port 118 is positioned to allow for gas and air to circulate out of the mechanical bay 106.

A thermo relief valve 105 may be provided such that if the pressure within the tank 102 increases, the pressure can be safely emitted from the tank. The thermo relief valve 105 ensures that the tank 102 does not obtain a positive pressure.

The transportable slurry box 101 may be constructed of rigid materials, such as steel or aluminum. The structure 103 materials must be of requisite strength to allow for the transportable slurry box 101 to be lifted and transported while the tank 102 is filed with materials. The tank 102 is constructed of materials capable of withstanding negative pressure up to a full vacuum. The transportable slurry box 101 may be constructed from a steel such as ASTM A537 Grade B. Traditionally most welded pressure vessels, storage tanks, and transportation equipment has been constructed from steels such as ASTM A516 and A442. A516 is a common carbon steel used. A516 may show signs of fatigue in artic conditions. A516 is generally rated with a lowest usual service temperature of −45 degrees Celsius.

Many steels exhibit ductile fracture at elevated temperatures and a brittle fracture at low temperatures. A ductile fracture is a type of fracture that is characterized by plastic deformation and necking. The plastic deformation and necking typically occurs prior to actual fracture. A brittle fracture is a type of fracture that is characterized by an actual fracture that is not proceeded by appreciable plastic deformation. Typically for steels, a lesser impact energy is required to cause a brittle fracture relative to a ductile fracture. Further, as a ductile fracture occurs, impact energy is absorbed by the steel undergoing deformation, whereas with a brittle fracture the steel actually fractures without appreciable plastic deformation such that impact energy is not absorbed while the steel deforms.

The temperature at which a steel transitions from a ductile fracture to a brittle fracture is known as the ductile-brittle transition. The ductile brittle transition is a temperature at which the impact energy needed to cause an actual fracture passes below a predetermined value. A test understood by persons in the industry is the Charpy impact test. The Charpy impact test establishes the predetermined value to be 40 Joule. Charpy impact test is sometimes referred to as the Charpy V-notch test in the steel industry. The Charpy impact test is a standardized high strain-rate test that involves striking a specimen with a value of impact energy.

Some grades of A516 may have a ductile brittle transition of around −30 degrees Celsius. Some grades of A537 and equivalents may have a ductile brittle transition less than the artic temperatures of −50 degrees Celsius. When referencing A537 or any other grade of metal, it is understood that the reference includes any similar or equivalent metal using a different grading system. A537 in some grades is rated for a lowest usual service temperature of −60 degrees Celsius. By selecting a steel that has a ductile brittle transition less than the artic temperatures, the steel is more suitable for use in the artic. Steel, such as A516, may effectively shatter in a brittle failure in extremely cold temperatures which are beneath the ductile brittle transition temperature.

Traditionally, roll-off containers have not been constructed from steels with a ductile brittle transition temperature less than −30 degrees Celsius. Typically, roll-off containers have been long constructed out of steels similar to A516. Vacuum trucks are a type of truck that is generally comprised of a vacuum tank and a vacuum pump which are permanently mounted to a truck frame. Vacuum trucks have traditionally been used to remove slurry cuttings from oil rig sites. Vacuum trucks traditionally have not been constructed from steels with a ductile brittle transition temperature less than −30 degrees Celsius. Typically, vacuum trucks have been long constructed out of steels similar to A516.

Steels with a ductile brittle transition less than −30 degrees Celsius have been used to some extent for stationary tanks in the artic. Identifying the specific characteristics of a suitable steel including the ductile brittle transition temperature is highly technical as there are many variations of steels. The selection of A537 Grade B is based on ductile brittle transition temperature, strength of material, fatigue limits, and workability for construction. A537 may be a difficult steel to use for equipment construction and specialized welding and manufacturing techniques may be required. More traditional steels such as A516 are less expensive than steels like A537. Given this cost constraint, those in the industry have been motivated to use less costly steels like A516.

Many different steels are engineered specifically for service at low temperature (about −100 C), selecting the optimum material calls for thorough understanding of the application and knowledge of the mechanical properties that each grade provides. It isn't as simple as selection based on temperature alone. An additional consideration when selecting a suitable type of steel for application on the slurry box 101 is fatigue limits. At low temperatures, systems are usually subjected to dynamic loads, and structural members to cycle stresses. Examples include the vacuum tank 102 that frequently undergo pressure changes and mobile equipment that experience extreme stress imposed by packed snow or high winds. Other considerations include heat conductivity and thermal expansion.

FIG. 2 is a perspective view of the transportable slurry box 101 mounted on the example vehicle 202. The vehicle 202 in this example is a tilt-bed roll-off type vehicle. The exemplary transportable slurry box 101 is shown as a cable type roll-off embodiment. Other types of vehicles and roll-off embodiments may be utilized. The vehicle 202 configured as a tilt-bed roll-off type vehicle is capable of pulling the transportable slurry box 101 onto the vehicle 202 and capable of causing the transportable slurry box 101 to be displaced from the vehicle 202. The vehicle may cause a transportable slurry box 101 to be displaced from the vehicle 202 and then pull a different transportable slurry box 101 onto the vehicle 202. A well site may require multiple slurry boxes placed on site.

In the illustrated embodiment, the transportable slurry box 101 is shown similar to a cable-type roll-off container. A cable-type roll-off container may be pulled or placed on a vehicle such as a tilt-bed vehicle or trailer using a winch or hydraulic rams with cables (FIG. 3). The vehicle 202 in the exemplary figure shows a tilt-bed roll-off type vehicle. The vehicle 202 is shown with a tilt-bed 301 and a cable 302. The cable 302 can be used to pull the transportable slurry box 101 onto the tilt-bed 301.

The cable 302 is attached to a winch and to a hook point 116 on the transportable slurry box 101. The transportable slurry box 101 may then be loaded 1050 onto the vehicle 202 utilizing pulling force from the winch. In an alternative embodiment, the transportable slurry box 101 may be built to allow the hook point to be attached near the top of the transportable slurry box 101 to allow for a hook-loader type vehicle to load the transportable slurry box 101 onto the vehicle 202.

A roll-on-roll-off vehicle may include, for example, a tilt-bed vehicle, a truck-trailer combination, a hook-loader, or a cable type vehicle. A truck-trailer combination-type vehicle may include, for example, a vehicle 202 where a truck pulls a trailer, the trailer which is a hook-loader type trailer or a tilt-bed type trailer. In a truck-trailer combination, the transportable slurry box 101 is pulled onto the trailer section of the truck-trailer combination just as a transportable slurry box 101 is pulled onto a tilt-bed vehicle or a hook-loader type vehicle. Alternatively, the vehicle 202 may be a sled configured to be transported in snowy and icy conditions. The sled is configured to handle both the weight and size of the transportable slurry box 101 after being filled. Commonly, a sled configured to be used in snowy and icy conditions is pulled by a tracked vehicle.

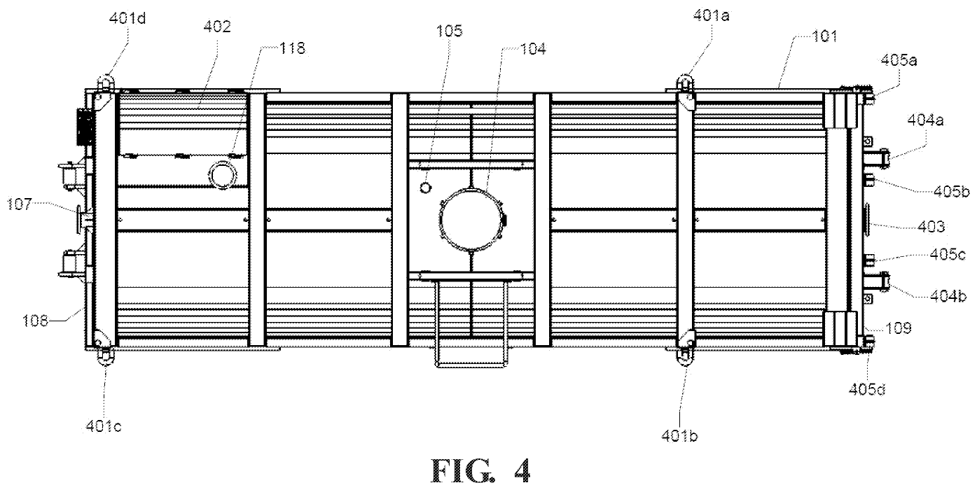

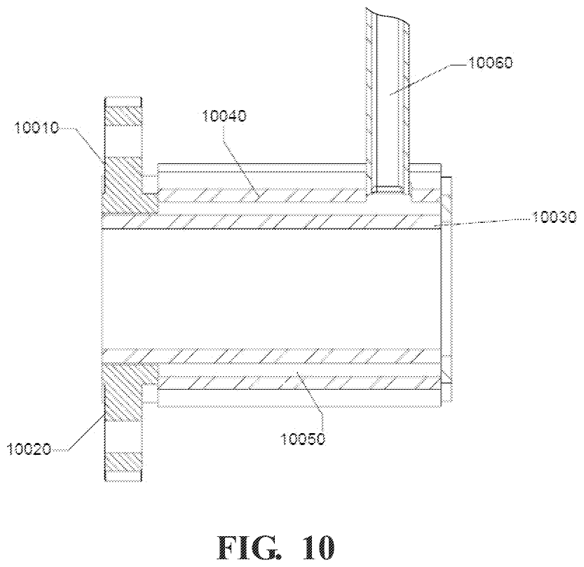

FIG. 4 is a view of the top of an exemplary transportable slurry box 101. Shown on the top of the transportable slurry box 101 is the manhole 104, the thermo relief valve 105, the exhaust port 118, as well as other transportable slurry box 101 features. In this embodiment, a set of lift hooks 401a, 401b, 401c, 401d are shown attached to the structure 103. The set of lift hooks 401a, 401b, 401c, 401d are positioned to allow for the transportable slurry box 101 to be picked up. Near the front 108 of the transportable slurry box 101 the mechanical bay 106 is shown. Access to the mechanical bay 106 can be had via a bay cover 402. At the front 108 of the transportable slurry box 101 a front pipe port 107 may be provided. At the rear 109 of the transportable slurry box 101 a rear pipe port 403 may be provided. Like the front pipe port 107, the rear pipe port 403 may be jacketed (FIG. 10) to allow for a heated fluid flow to be circulated around the inner surface such to keep the material within the tank 102 and within the jacketed flange from freezing.

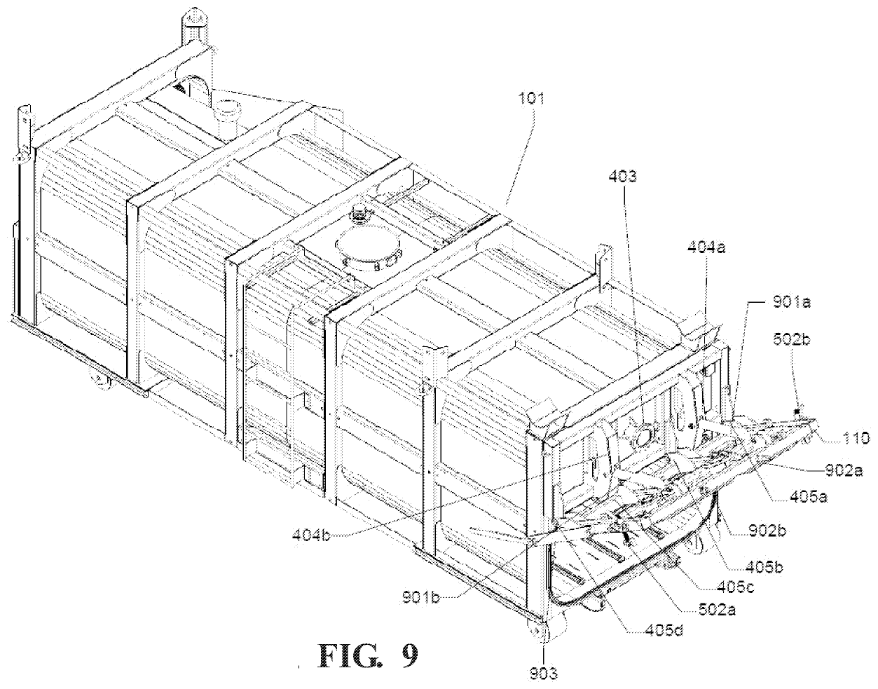

At the rear 109 of the transportable slurry box 101 a hydraulic mount 404a, 404b is shown where a hydraulic cylinder may be connected (FIG. 9). The hydraulic cylinder may be connected on the opposite end to the tailgate 110. When hydraulic pressure is delivered to the hydraulic cylinder, the tailgate 110 may be opened or closed by the retracting or extending of the hydraulic cylinder. The tailgate 110 is attached to the transportable slurry box 101 with at least one tailgate hinge 405. In this embodiment, four hinges are shown.

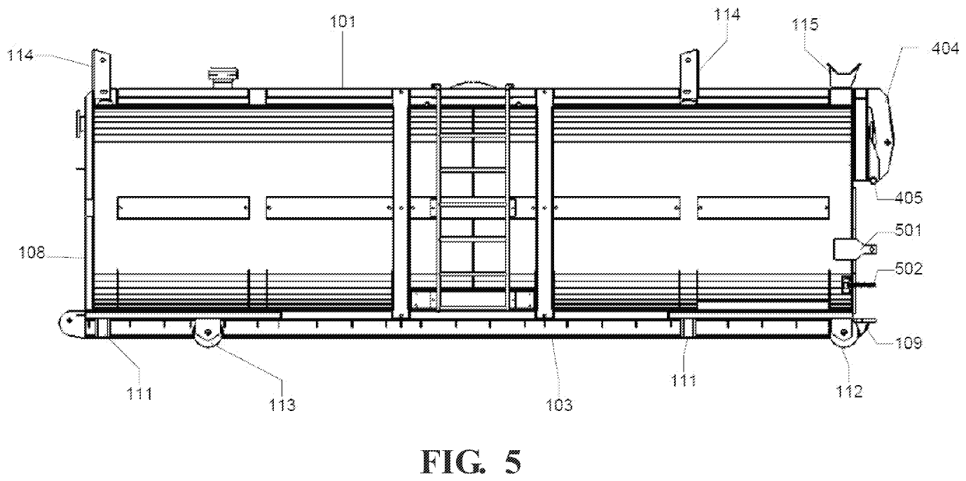

With reference to FIG. 5, a driver-side view of the structure 103 illustrates the front wheel set 113 and a rear wheel set 112. A stacking leg 111 is attached near the front 108 of the transportable slurry box 101 and near the rear 109. A stacking mount 114 is attached near the front 108 of the transportable slurry box 101 and near the rear 109. A rear wheel platform 115 is shown near the rear 109 of the transportable slurry box 101.

At the rear 109 of the transportable slurry box 101, a hydraulic mount 404 is shown. In FIG. 5 the tailgate 110 and hydraulic cylinders are removed from the drawing. At least one tailgate hinge 405 is shown. A latch receiver 501 is attached to the tank 102. The latch receiver 501 interfaces with the tailgate 110 such that when the tailgate 110 is in the closed position, a hydraulic latch mounted on the tailgate 110 secures into the latch receiver 501. When the hydraulic latch is secured into the latch receiver 501, the tailgate 110 may not be moved from the closed position. The closed position is when the tailgate 110 is secured to the tank 102 and a fluid seal is made between the tank 102 and the tailgate 110. A manual latch 502 is attached to the tank 102. The manual latch 502 in this exemplary embodiment comprises a threaded bolt and a wingnut secured on the threaded bolt when the tailgate 110 is in the closed position. The wingnut in the example, is to be removed by an operator.

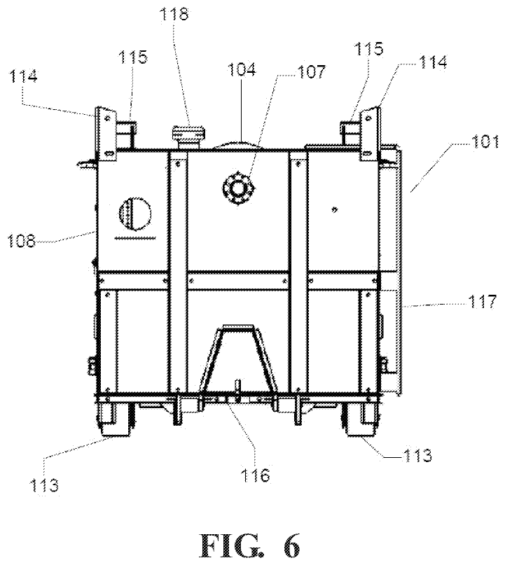

With reference to FIG. 6, a view of the front 108 of the transportable slurry box 101. Shown in the figure is the front pipe port 107 near the top of the transportable slurry box 101. Mounted near the top of the transportable slurry box 101 is at least one stacking mount 114. In the figure, two stacking mounts are displayed. At the bottom of the transportable slurry box 101 at least one front wheel set 113 is shown. In the exemplary figure, two wheels are shown. A hook point 116 is shown in the figure. Shown in the figure is a partial view of a set of rear wheel platforms, a partial view of the manhole 104, and the exhaust port 118. On the side of the transportable slurry box 101 can be seen a side profile of the ladder 117.

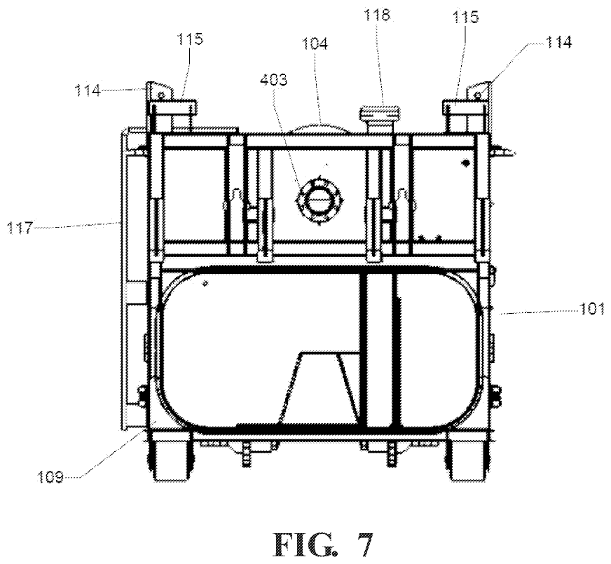

With reference to FIG. 7, the transportable slurry box 101 includes at least one rear wheel platform 115. Shown in this embodiment is two rear wheel platforms. In one embodiment, the rear wheel platform 115 may be displaced outward with respect to the rear of the vehicle. Alternatively, the transportable slurry box 101 may be configured without any rear wheel platforms. At least one stacking mount 114 is attached to the transportable slurry box 101. In the figure two stacking mounts are displayed. On the side of the transportable slurry box 101 can be seen a side profile of the ladder 117. The manhole 104 and the exhaust port 118 may be located at the top of the transportable slurry box. The manhole 104, the ladder 117, and the exhaust port 118 are not essential in all embodiments of the invention disclosed in this description. An optional rear pipe port 403 is shown.

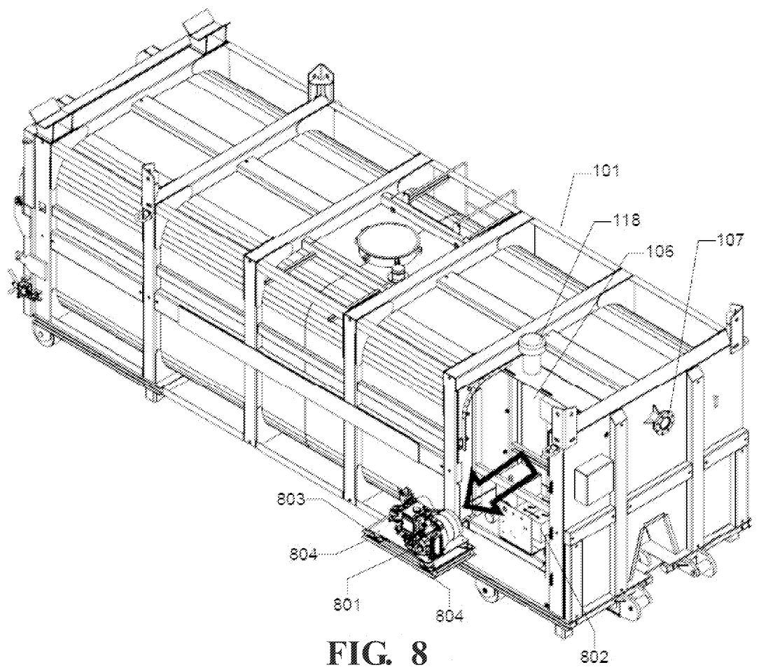

With reference to FIG. 8, the power unit 801 can be selectively removed from the transportable slurry box 101. The transportable slurry box 101 is shown with a bay cover 402 opened such to allow access to the mechanical bay 106. The exhaust port 118 allows for exhaust to be vented from the mechanical bay 106. In the exemplary figure a diesel engine is shown as the power unit 801. The power unit 801 is connected to a hydraulic pump to produce hydraulic pressure, connected to a pump to provide a fluid flow through the warming tubes, and configured to provide heat energy to the fluid within the warming tubes. The diesel engine may be substituted with an alternative power unit device. Such alternatives include but are not limited to an electric motor, a gasoline engine, a turbine, or any other such device appreciated by one with ordinary skill in the art. The power unit 801 uses an energy source 802 attached to the transportable slurry box 101. The energy source 802 may be electrical energy, chemical energy, gasoline, diesel, or other such energy source 802 which is compliant with the relevant power unit 801.

The power unit 801 may be configured on a skid 803 which allows for the power unit 801 to be removed from the mechanical bay 106. The skid 803 may be configured with one or more forklift pockets 804 to allow for the skid 803 and items supported thereby to be removed from the mechanical bay 106 using a forklift. In embodiments, the hydraulic pump and/or other components may be attached to the skid 803 to allow for removal from the mechanical bay 106. Any type of quick disconnect connectors understood by a person of ordinary skill in the art may be used to connect the skid 803 and items to which it is attached to warming tubes, hydraulic lines, electrical connections, and other elements on the transportable slurry box 101.

With reference to FIG. 9, a perspective of the transportable slurry box 101 illustrates the tailgate 110 in the open position. The tailgate 110 may be opened using hydraulic force or any other force. In some embodiments, at least one hydraulic cylinder 901 is used to open and close the tailgate 110. In the figure, two hydraulic cylinders are connected between the tailgate 110 and each hydraulic mount 404. The tailgate 110 is attached to the tank 102 by at least one tailgate hinge 405. The one or more hinges may be attached to the structure 103 or may be attached to the tank 102. The tailgate 110 closes such that it is attached to the tank 102 and fluidly seals the tank 102 when it is closed. In the exemplary embodiment a set of four hinges 405a, 405b, 405c, 405d are shown which comprise the tailgate hinge 405. The tailgate hinge 405 is configured such that its axis is parallel to the bottom of the structure 103. The tailgate 110 pivots on the tailgate hinge 405 such that it opens vertically.

When the tailgate 110 is moved to the closed position such that the tailgate 110 fluidly seals the tank 102, the tailgate seals the tank 102. The tailgate 110 can be secured against the tank 102 using a latch receiver 501, a manual latch 502 as shown in FIG. 5, as shown in FIG. 9, or other such system.

In FIG. 9 one embodiment of the manual latch 502 is shown. A vertical latch 902 may be used to secure the tailgate 110. The vertical latch 902 in this embodiment is functioned by a hydraulic force. A safety brace 903 may be attached to the structure 103 to ensure the tailgate 110 is forcefully maintained in an open position such that the tailgate 110 may not close due to the force of gravity or due to hydraulic force from a hydraulic cylinder 901. The safety brace 903 is hingedly attached to the structure 103 or tank 102 and is configured such that the tailgate 110 may not close when the safety brace 903 is positioned against the tailgate 110.

The vertical tailgate may be opened using hydraulic force. In some embodiments, at least one hydraulic cylinder is used to open and close the vertical tailgate. The vertical tailgate is attached to the tank 102 by at least one tailgate hinge. The one or more hinges may be attached to the structure 103 or may be attached to the tank 102. The vertical tailgate closes so as to fluidly seal the tank 102. In the exemplary embodiment a set of four hinges may be used which comprise the hinge. The tailgate hinge is configured such that its axis is parallel to the bottom of the structure. The vertical tailgate pivots on the tailgate hinge such that it opens vertically.

The mechanical bay 106 may be located within the transportable slurry box 101. In the mechanical bay 106, certain ancillary equipment is located. A power unit for providing heat energy to fluid within a system of warming tubes and jacketed openings is located in the mechanical bay 106. The power unit may also provide energy to power a hydraulic pump to produce flow and pressure to operate various hydraulic functions. Such hydraulic functions include but are not limited to hydraulically opening the vertical tailgate. The power unit may be a diesel engine with a fuel tank, an electric motor with a battery bank, or any other method as appreciated by one with ordinary skill in the art. The mechanical bay 106 may be designed to allow for the power unit to be disconnected and removed when not needed. The exhaust port 118 is positioned to allow for gas and air to circulate out of the mechanical bay 106.

A transportable slurry box 101 in other embodiments also comprises a vertical tailgate which allows for the transportable slurry box 101 to be unloaded in a compact space and the capability to heat the contents of the transportable slurry box 101 to a temperature above freezing. The heating capability may be by the circulation of a heated flow of liquid through the system of warming tubes distributed through the transportable slurry box 101. The system of warming tubes is configured with a particular design that doesn't impede the payload to slide out. Multiple slurry boxes may be stacked to conserve room on a well site. Multiple slurry boxes as disclosed herein may be stored at an oil rig site to allow the oil rig to continue operating during inclement weather. For example, there may be a second slurry box and a third slurry box to form a transportable slurry box stack.

With reference to FIG. 10, an example jacketed flange 10010 is illustrated. The disclosed jacketed flange 10010 may be utilized with the front pipe port 107, the rear pipe port 403, or any other port in the tank 102 to provide a heated port to avoid freezing of materials therein. The jacketed flange 10010 comprises of a flange face 10020, an inner surface 10030, an exterior surface 10040, and a warming channel 10050. Attached to the jacketed flange 10010 is a warming tube 10060. The warming tube 10060 conveys the heated fluid flow to the jacketed flange 10010 warming channel 10050. The heated fluid flow is fluid which was heated by the power unit 801. The warming tube 10060 may be connected from any angle or location. The heated fluid flow which is conveyed to the warming channel 10050 maintains a temperature which causes any material located within the area contained by the inner surface 10030 to remain above a freeze temperature. The inner surface 10030 is essentially an opening which allows material to flow through. The exterior surface 10040 encloses the inner surface 10030.

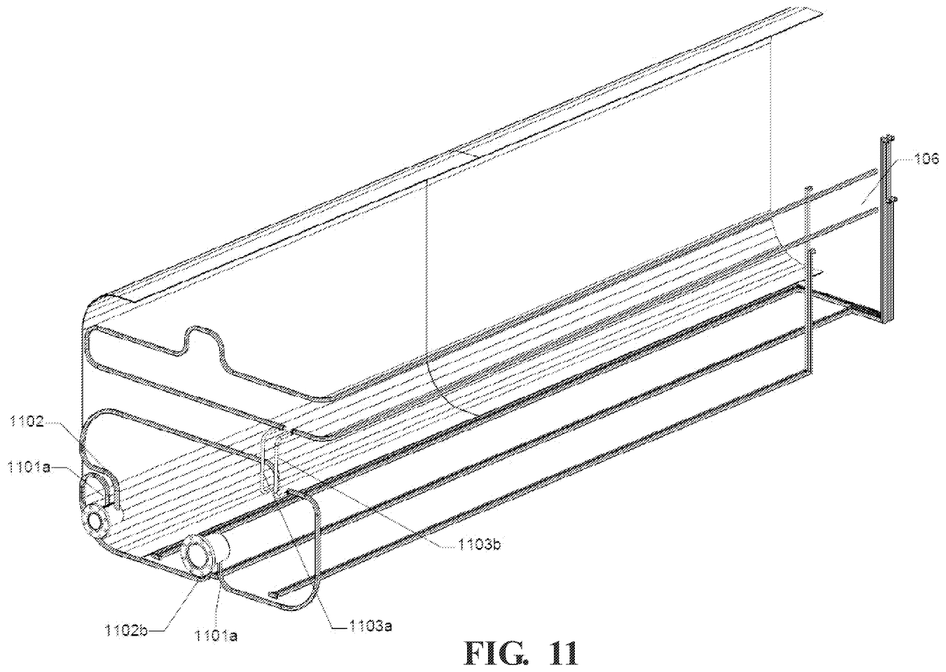

With reference to FIG. 11, a set of warming tubes are schematically illustrated. The figure does not include all potential warming tubes which may be attached to the tank 102. Shown are two jacketed flanges which represent the location at which the tailgate 110 would be positioned when closed. The two shown flanges would be attached to the tailgate 110. A supply warming tube 1101 and an exit warming tube 1102 is attached to each of the jacketed flanges. Hinge warming tubes 1103 are used to connect warming tubes in the tailgate 110 to warming tubes attached to the tank 102. Warming tubes are configured to be positioned such to connect to connectors in the mechanical bay 106.

The transportable slurry box 101 can be placed on a vehicle 202 for transportation or moved at a particular location. For example, the vehicle 202 can be a self-loading vehicle which can pull the transportable slurry box 101 onto the vehicle 202. An example of a vehicle that can be used with the transportable slurry box 101 is that which is traditionally understood as a roll-off truck. With this, the transportable slurry box 101 can be loaded or unloaded from a vehicle 202. The transportable slurry box 101 includes at least a tank 102 that can hold a vacuum when a vacuum pump is fluidly connected to the vacuum tank. The vacuum can cause material such as drilling cuttings to be drawn into the vacuum tank.

The mechanical bay 106 may be located within the transportable slurry box 101. In the mechanical bay 106, certain ancillary equipment is located. A power unit for providing heat energy to fluid within a system of warming tubes and jacketed openings is located in the mechanical bay 106. The power unit may also provide a motive force to power a hydraulic pump to produce flow and pressure that may be utilized to operate various hydraulic functions. Such hydraulic functions include, but are not limited to, hydraulically opening the vertical tailgate, operating hydraulic locks, etc. The power unit may be a diesel engine with a fuel tank, an electric motor with a battery bank, or any other such device. The mechanical bay 106 may be designed to allow for the power unit to be disconnected and removed when not needed. The exhaust port 118 is positioned to allow for gas and air to circulate out of the mechanical bay 106.

In summer months, the heating function of the transportable slurry box 101 may not be needed. In summer months, frozen roads during winter may have thawed and become rough, causing additional wear and tear on equipment being transported thereon. Removal of such equipment from the mechanical bay 106 when not needed avoids such wear and tear on relatively expensive and somewhat delicate equipment.

The vertical tailgate allows for the transportable slurry box 101 to be unloaded in a compact space and the capability to heat the contents of the transportable slurry box 101 to a temperature above freezing. The heating capability may be by the circulation of a heated flow of liquid through the system of warming tubes distributed through the transportable slurry box 101, electrical power strips, etc. The system of warming tubes are configured with a particular design that doesn't impede the payload to slide out. Multiple slurry boxes may be stacked to conserve room on a well site. Multiple slurry boxes as disclosed herein may be stored at an oil rig site to allow the oil rig to continue operating during inclement weather. For example, there may be a second slurry box and a third slurry box.

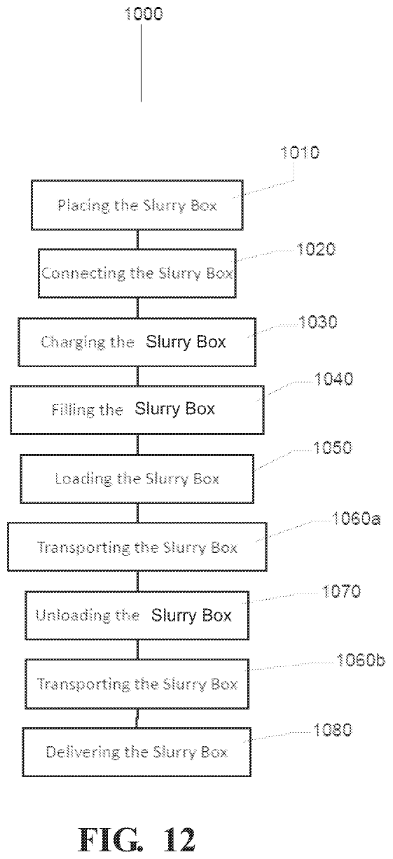

With reference to FIG. 12, a simplified block diagram illustrates a method in which a transportable slurry box 101 is used efficiently according to one disclosed non-limiting embodiment. The disclosed method 1000 generally includes placing 1010 the transportable slurry box 101 so it can be connected to an oil rig; connecting 1020 the transportable slurry box 101; charging 1030 the tank 102; filling 1040 the tank; loading 1050 the transportable slurry box 101 onto the vehicle 202; transporting 1060a the transportable slurry box 101 to a disposal facility; unloading 1070 the vacuum tank; transporting 1060b the transportable slurry box 101 to an oil rig site; and delivering 1080 the transportable slurry box 101 to an oil rig site for reuse. For the purpose of this application, an oil rig site refers to a drill site which may be either an oil or gas rig site. For this application, an oil rig refers to either an oil or gas rig.

The steps as described and shown need not start with placing 1010 the transportable slurry box 101; rather, the disclosed method can start and end at any step within the disclosed process. For example, the disclosed method may start with transporting 1060b the transportable slurry box 101 to an oil rig site and end with unloading 1070 the transportable slurry box 101 at a disposal facility.

The step of placing 1010 a transportable slurry box 101 at an oil rig site includes the act of moving the transportable slurry box 101 to a location near the oil rig such that the transportable slurry box 101 may be connected to a vacuum source, and the inlet of the transportable slurry box 101 is connected to the cuttings slurry outlet attached to the oil rig. The oil rig operator typically designates the location at which the transportable slurry box 101 is placed. The location at which the transportable slurry box 101 is placed may be different from where the transportable slurry box 101 is delivered 1080 to the oil rig site. The transportable slurry box 101 may be moved from a storage location designated at the oil rig site to where the transportable slurry box is to be placed 1010. Slurry boxes may be stacked vertically at the oil rig site for storage purposes. The transportable slurry box 101 may be removed from a stack and then placed 1010.

Alternatively, a vehicle 202 may deliver 1080 a transportable slurry box 101 to an oil rig site in a way that the vehicle 202 places 1010 the transportable slurry box 101. The vehicle 202 may have the capability to self-load and self-unload. When a vehicle 202 which is delivering 1080 the transportable slurry box 101 places 1010 the transportable slurry box 101, the transportable slurry box 101 is not being moved from a storage location on the oil rig site. Rather it is being placed 1010 directly from the vehicle 202.

The step of connecting 1020 the transportable slurry box 101 includes may include configuring the inlet of the tank 102 to be fluidly attached to the cuttings slurry outlet attached to the oil rig, and fluidly attaching the vacuum port to a vacuum source. When a transportable slurry box 101 is properly placed 1010 at an oil rig site, the connecting 1020 step can occur.

An inlet on the transportable slurry box 101 is an opening in the tank 102 through which cuttings slurry can flow into the tank 102 from a pipe or hose. The inlet is configured such that it can fluidly seal to the cuttings slurry outlet of the oil rig. Typically, the inlet may include a flanged pipe or quick connect hose. However, when not fluidly attached to the outlet, the inlet may be fluidly sealed to not allow debris to enter the vacuum tank.

A vacuum port on the transportable slurry box 101 is an opening in the tank 102 through which a vacuum source may charge 1030 the tank 102 with a vacuum. The vacuum port is configured such that it can fluidly seal to a vacuum source. Typically, the vacuum port will include a flanged pipe or quick connect hose such as front pipe port 107 or rear pipe port 403. However, when not fluidly attached to the vacuum source, the vacuum port may be fluidly sealed such to not allow debris to enter the vacuum tank.

The vacuum source may be provided by a vacuum pump located at the oil rig site. The vacuum pump is sized accordingly such that it can remove air from the tank 102 such that the tank 102 becomes under vacuum pressure. The vacuum pump can be a stand-alone unit designated for use with slurry boxes or can be a vacuum pump used for purposes beyond the transportable slurry box 101. The vacuum pump can be driven by electric energy, an internal combustion engine, a diesel engine, or any other power source.

Drill cuttings are produced during drilling of oil wells and gas wells. The drill cuttings are carried to the surface by a drilling fluid circulating up from the drill bit. The drill cuttings are separated from the drilling fluid so the recycled drilling fluid may be reused during the drilling process. The separated drill cuttings and a portion of the drilling fluid and other liquids form the cuttings slurry that must be removed from the oil rig site. Cuttings slurry is expressed from the oil rig through an outlet. The outlet may be pumped from the oil rig itself, mud pits, or a holding tank. In the disclosed process herein, the outlet must be configured to fluidly attach to the inlet of the transportable slurry box 101.

The step of charging 1030 the transportable slurry box 101 includes pulling a vacuum on the vacuum tank. Once the transportable slurry box 101 is connected 1020, the tank 102 is fluidly sealed from the atmosphere and the only external connections attached to the tank 102 are through the inlet and vacuum port. When the tank 102 is sealed from the atmosphere, a vacuum can be charged 1030 to the tank. For the sake of this application, charging a vacuum is understood to be the act of removing air from the tank 102 and therefore creating a negative pressure within the vacuum tank. Vacuum Pressure is the state in which the tank 102 is in when in a vacuum. When at vacuum pressure, the tank 102 is charged to a pressure that is less than atmospheric pressure and less than the pressure in the cuttings slurry outlet, such that cuttings slurry may be filled 1040 into the transportable slurry box 101. The vacuum can range from slightly below atmospheric pressure to a full vacuum, depending on how quickly the oil rig operator wishes the cuttings slurry to flow into the vacuum tank. The vacuum pump can be configured to continue to charge 1030 vacuum pressure into the tank 102 until the tank 102 is filled with cuttings slurry to such a level as desired by the oil rig operator or transport operator.

The step of filling 1040 the tank 102 is to allow cuttings slurry to be pulled into the tank 102 by the force of the vacuum pressure charged 1030 into the vacuum tank. As cuttings slurry is pulled into the vacuum tank, the vacuum pump can continue to charge 1030 the tank 102 until the desired level of cuttings slurry is filled into the vacuum tank. An exterior fill level gauge may be configured on the transportable slurry box 101. By watching the exterior level gauge, the operator may visually monitor the amount of cuttings slurry filling the transportable slurry box 101 so to ensure the transportable slurry box 101 is not overfilled beyond the intended amount per load.

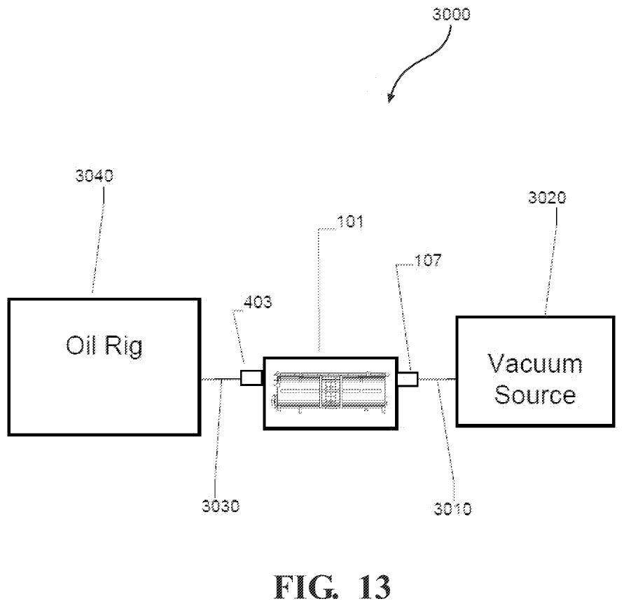

Once the tank 102 on the transportable slurry box 101 is filled 1040 to the desired level, the transportable slurry box 101 may be disconnected from the oil rig cuttings slurry output and disconnected from the vacuum source (FIG. 13). The transportable slurry box 101 may then be moved to another location at the oil rig site or directly loaded 1050 onto a vehicle 202. Moving the transportable slurry box 101 to another location at the oil rig site allows for a different transportable slurry box 101 to be placed 1010 to connect 1020. Slurry boxes that are moved to another location at the oil rig site are placed in a location for storage. While in storage, the oil rig operator can choose to stack multiple slurry boxes vertically.

Stacking slurry boxes 101a, 101b (FIG. 14). reduces the land area needed at an oil rig site. The transportable slurry box 101 may be stacked vertically when more than one transportable slurry box 101 is used. Many gas or oil rig sites have limited space on which equipment can be placed and the ability to stack the transportable slurry boxes is a valuable function. The transportable slurry box 101 may be lifted using d-rings, slings cables, or chains, a forklift, or any other lifting mechanism. The transportable slurry box 101 need only be moved into a storage location for a temporal period and will eventually be loaded 1050 onto a vehicle 202.

Loading 1050 a transportable slurry box 101 onto a vehicle 202 may include lifting the transportable slurry box 101 onto a vehicle 202. The transportable slurry box 101 may be loaded 1050 onto a vehicle 202 by force exerted from a pulling object. For example, a roll-off type vehicle could use a winch, a hydraulic ram, or a hook arm to pull the transportable slurry box 101 onto the vehicle 202. Alternatively, the transportable slurry box 101 may be loaded 1050 onto a vehicle 202 by lifting the transportable slurry box 101 with an external device. For example, a forklift or a crane could pick up the transportable slurry box 101 and load it onto the vehicle 202.

Transporting 1060a the transportable slurry box 101 to a disposal facility includes physically moving the transportable slurry box 101, which has been loaded 1050 on the vehicle 202 from the oil rig site to the disposal facility where it will be unloaded 1070. The transportable slurry box 101 is transported 1060 on the vehicle 202 at two times in the disclosed method of use. The function of transporting 1060a the transportable slurry box 101 to the disposal facility and transporting 1060b the transportable slurry box 101 to the oil rig site essentially comprise the same functions and are both considered transporting 1060. Transporting includes moving the transportable slurry box 101 between the disposal facility and the oil rig site.

Transporting 1060 the transportable slurry box 101 can be performed by a vehicle 202 which is motorized or can be performed by pulling the vehicle 202 with another device. The transporting 1060 function can be performed over a wide geographic region or may be a relatively short distance. The transporting 1060 may also include one or more transitions wherein the transportable slurry box 101 is loaded 1050 on the vehicle 202 is removed from the vehicle 202 and placed on another vehicle 202. For example, the transportable slurry box 101 might be loaded 1050 on a vehicle 202 at the oil rig site which is of a sled embodiment. Once the transportable slurry box 101 is transported 1060 a certain distance, the transportable slurry box 101 may be transitioned onto the vehicle 202 of a roll-off embodiment. At this point, the transportable slurry box 101 continues to be transported 1060 to the disposal facility. During the transporting 1060, the transportable slurry box 101 may be transitioned multiple times. Different vehicles may be used for different portions of the transporting steps. For example, a sled may be used for at least a portion of the transporting.

Unloading 1070 the transportable slurry box 101 includes emptying the cuttings slurry from the tank 102 within the transportable slurry box 101. Once the transportable slurry box 101 has been transported 1060a to the disposal facility, the transportable slurry box 101 is positioned at a location at the disposal facility wherein the transportable slurry box 101 is to be unloaded 1070. Multiple methods can be employed to unload 1070 the tank 102 within the transportable slurry box 101. Methods to unload 1070 include but are not limited to dumping, using vacuum force, or scooping the cuttings slurry from the vacuum tank.

Transporting 1060b the transportable slurry box 101 to an oil rig site includes physically moving the transportable slurry box 101 on a vehicle 202 from the disposal facility to the oil rig site.

Delivering 1080 the transportable slurry box 101 to the oil rig site is to remove the transportable slurry box 101 from the vehicle 202 upon which the transportable slurry box 101 was transported 1060. The transportable slurry box 101 may be delivered 1080 at a location at the oil rig site used for storage or may be delivered 1080 to the location at the oil rig site wherein the transportable slurry box 101 will be placed 101. If the transportable slurry box 101 is delivered at a location used for storage, the transportable slurry box 101 may be stacked.

With reference to FIG. 13, a schematic view of an exemplary transportable slurry box 101 at an example oil rig site 3000 is illustrated. A pipe 3010 is utilized to connect the vacuum port to a vacuum source 3020. Another pipe 3030 or hose may be connected from the rear pipe port 403 to the oil rig 3040 such the cuttings slurry may be communicated into the transportable slurry box 101.

With reference to FIG. 14, a perspective view of two slurry boxes stacked on top of each other. Shown in the figure is a bottom slurry box 101a and an upper slurry box 101b. The transportable slurry boxes are stacked on top of each other to save space. More than two slurry boxes may be stacked.

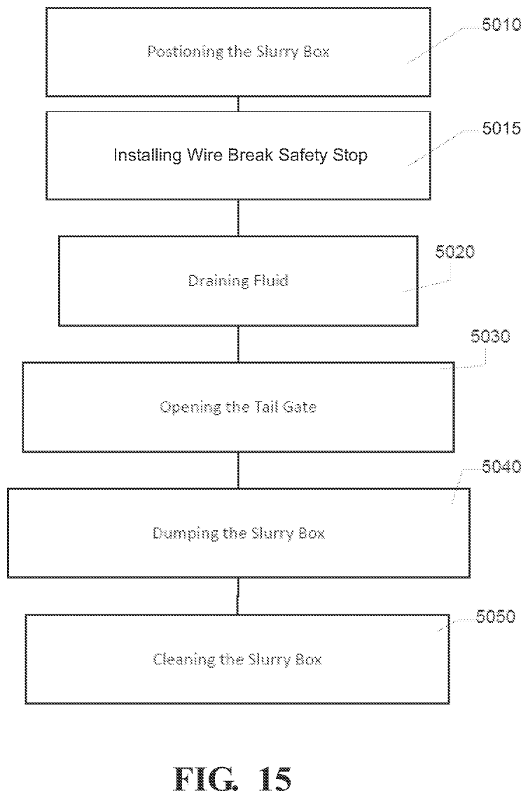

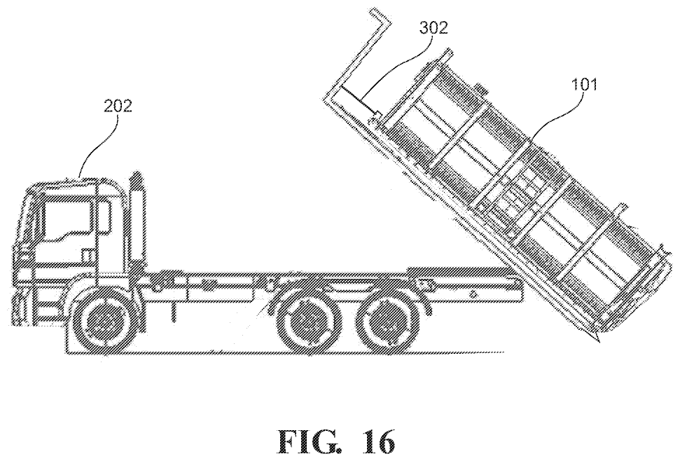

With reference to FIG. 15, a simplified block diagram shows a method in which the transportable slurry box 101 carried upon a roll-on-roll-off vehicle is unloaded 5000 (FIG. 16) which may be one type of unloading contemplated in the unloading 1070 step identified above. The vehicle 202, in this embodiment, is a roll-off vehicle. For the purpose of dumping 5040, the transportable slurry box 101 may be held above the ground surface 602 or be permitted to touch the ground surface 602. The transportable slurry box 101 need not touch the ground surface 602 while in the raised position to facilitate dumping. The transportable slurry box 101 may later be placed by the vehicle 202 on the ground surface once unloaded for storage until reuse.

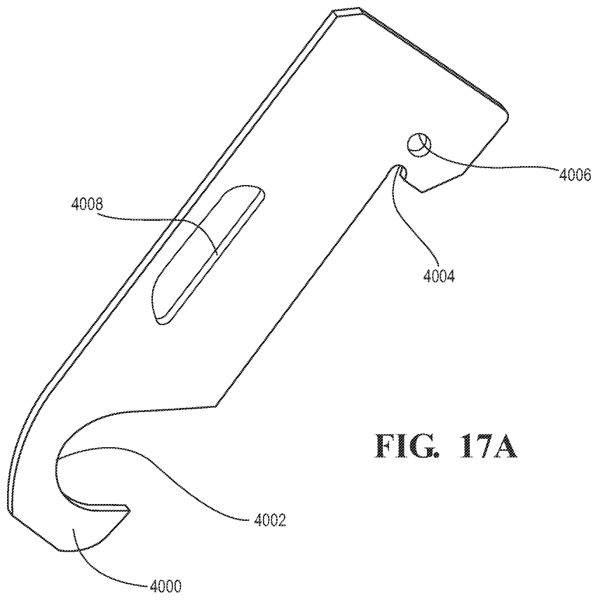

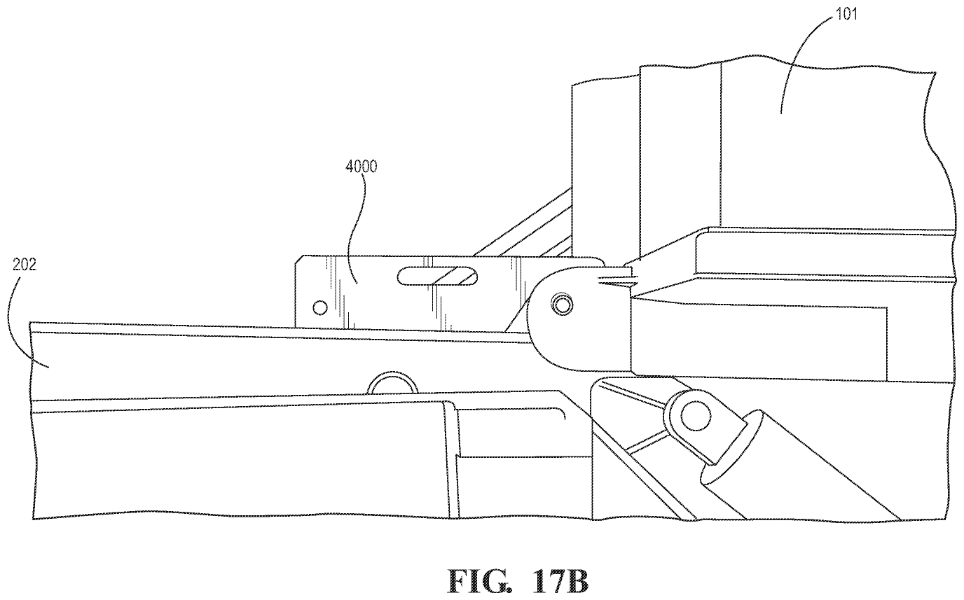

The disclosed method includes positioning 5010 the transportable slurry box 101 at a location at the disposal facility; manually installing 5015 a wire break safety stop 4000 (FIGS. 17A and 17B); draining 5020 fluid from the transportable slurry box 101; opening 5030 the tailgate on the transportable slurry box 101; dumping 5040 the transportable slurry box 101; and cleaning 5050 the transportable slurry box 101. The transportable slurry box 101 may then be stored such as by stacking, transported 1060 to an oil rig site, or used for other purposes.

Positioning 5010 the transportable slurry box 101 at a disposal facility location is moving the transportable slurry box 101 to the place where the transportable slurry box 101 may be emptied of cuttings slurry. Often the disposal facility is constructed such that the transportable slurry box 101 must be positioned 5010 in a location that does not allow for excess space horizontally around the vehicle 202 and slurry box 101. This may require that the transportable slurry box 101 will not be provided space to open a horizontal tailgate horizontally; rather the transportable slurry box 101 provides for a more compact vertical opening.

Draining 5020 the transportable slurry box 101 includes emptying the transportable slurry box 101 of unconstrained fluid. The unconstrained fluid may be free-standing on the surface of the cuttings slurry or may be within the cuttings slurry. Draining 5020 the transportable slurry box 101 includes opening a port in the tank 102 and tilting the transportable slurry box such that the fluid flows through the port out of the vacuum tank. The port used to drain the fluid may be the inlet of the transportable slurry box 101 used for filling 1040 the vacuum tank.

An elbow, hose, or other fitting may be attached to the opening, such as the inlet to direct the fluid as it is emptied from the vacuum tank. A valve may be used to control the flow of fluid and cuttings slurry from the vacuum tank. When the transportable slurry box 101 is on a roll-off vehicle, the transportable slurry box 101 may undergo the step of sliding back toward the rear of the vehicle 202 to accommodate draining 5020 and dumping 5040 (FIG. 16). In such roll-off vehicle applications, the transportable slurry box 101 may be partially raised by the vehicle and then typically slid approximately 2.4 meters (8 feet) toward the rear of the vehicle 202 under restraint of the cable 302 (FIG. 16). Various steps may require the transportable slurry box 101 to be partially raised and or otherwise positioned.

The wire break safety stop 4000 (FIG. 17A) is then manually installed 5015 (FIG. 17B) by an operator to secure the transportable slurry box 101 to the vehicle 202 irrespective of the cable 302. That is, should the cable 302 become inoperative, the wire break safety stop 4000 will retain the transportable slurry box 101 to the vehicle 202 when in the raised position. This increases the safety of the operators as they are often located just aft of the raised transportable slurry box 101.

To facilitate the draining 5020, the vehicle 202 may be configured to raise the transportable slurry box 101 such that one end of the transportable slurry box 101 is higher than the end which is opened to empty fluid from the vacuum tank. Raising one end of the transportable slurry box 101 is considered tilting the transportable slurry box 101. Once the requisite amount of unconstrained fluid is emptied from the vacuum tank, as determined by the vehicle 202 operator, the transportable slurry box 101 may be lowered back to a horizontal position.

Opening 5030 the transportable slurry box 101 includes causing the tailgate to be opened. At the rear of the transportable slurry box 101 the tailgate is attached to hinges allowing the tailgate to be mechanically opened vertically with respect to a bottom of the transportable slurry box 101. Attaching the tailgate on the transportable slurry box 101 so that it is vertically opened ensures that the transportable slurry box 101 does not need additional lateral space on either side. In many applications, the transportable slurry box 101 needs to be unloaded at sites that do not allow for excess horizontal space around the transportable slurry box 101. When closed, the tailgate is sealed to the tank 102 such that the tank 102 may, in some embodiments, maintain a vacuum pressure.

The tailgate can be secured against the tank 102 by force or may use one or more latches. The latches may be manually, mechanically and/or hydraulically operated. In addition, a safety brace may be attached to the transportable slurry box 101 to ensure the tailgate is securely maintained in an open position such that the tailgate may not close due to the force of gravity should a lack of hydraulic force occur. The mechanical safety brace obviates safety concerns due to an inadvertently, such as by loss of hydraulic power, closing tailgate.

Opening 5030 the tailgate may include unlatching latches, applying force to cause the tailgate to move to an open position, and applying the safety brace when configured. The open position is typically such that the tailgate is at a 90-120-degree position relative to the position when fluidly sealed against the vacuum tank. A control such as a handheld remote may be used to cause the tailgate to move to an open position.

Dumping 5040 the transportable slurry box 101 may include raising the transportable slurry box to cause the cuttings slurry to empty from the vacuum tank. The step of dumping 5040 the transportable slurry box 101 may include raising the transportable slurry box 101 as previously describe in the draining 5020 step. The dumping 5040 may proceed once the tailgate has been opened 5030. In the dumping 5040, typically both drill cuttings and fluids forming the cuttings slurry are emptied from the vacuum box.

Draining 5020 the unconstrained fluid prior to dumping 5040 the transportable slurry box 101 is to control the mass emptied from the vacuum tank. If the tank 102 was emptied of all cuttings slurry by skipping to the dumping 5040 step, the mass of cuttings slurry emptied out of the tank 102 would be uncontrolled. The mass would be uncontrolled because the cuttings slurry is comprised of solid drill cuttings and fluids. The cuttings slurry is a mix of solid and liquid such that it is in akin to a mud. Dumping such a load of material results in an uncontrolled dump and will result in a mess.

Once the dumping 5040 has been completed, the cleaning 5050 step may commence. The step of cleaning 5050 the transportable slurry box 101 is generally comprised of using pressurized fluid to spray remaining cuttings slurry from the tank 102 and washing debris from seals on the vacuum tank. After the transportable slurry box 101 is drained 5020 and dumped 5040, some cuttings slurry will likely remain in the tank 102 due to adhesion to various surfaces. Pressurize fluid may be used to ensure the remaining cuttings slurry is emptied out of the vacuum tank. The fluid need not be under high pressure, rather any amount of pressure sufficient to spray fluid is required. For example, a garden hose spraying water at 50 PSI may be a sufficient spraying source.

Cleaning 5050 includes washing debris from seals on the vacuum tank. Specifically, a seal that causes the tailgate to be fluidly sealed to the tank 102 should undergo washing to ensure the tailgate can continue to seal between the tailgate and the vacuum tank. The seal is compressed between the tank 102 and the tailgate. The washing of the seals may simply include using the pressurized water to spray debris from the seal or may include the act of scrubbing debris from the seals.

With reference to FIG. 17A, the wire break safety stop 4000 may be provides as a steel plate with a transportable slurry box hook 4002 and a vehicle engagement hook 4004 opposite the transportable slurry box hook 4002. The transportable slurry box hook 4002 may be sized to engage the transportable slurry box 101 adjacent to where the cable 302 engages the transportable slurry box 101. The vehicle engagement hook 4004 engages the vehicle 202 at, for example, the frame which may require only minor modification to convectional frames to provide for engagement. An aperture 4006 that also engages with the vehicle 202 (FIG. 17B) may alternatively or additionally be provided to further retain the wire break safety stop 4000 until the transportable slurry box hook 4002 and the vehicle engagement hook 4004 are engaged. A handle aperture 4008 between the transportable slurry box hook 4002 and the vehicle engagement hook 4004 may also be included in the wire break safety stop 4000 to facilitate handling of the relatively substantial wire break safety stop 4000. The wire break safety stop 4000 is readily installed by an operator to secure the transportable slurry box 101 to the vehicle 202.

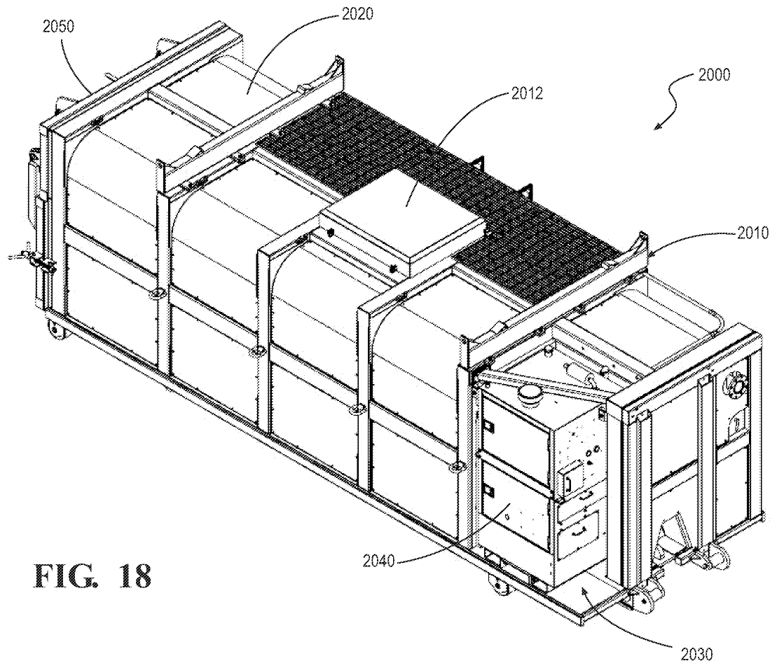

With reference to FIG. 18, according to another disclosed embodiment, a transportable slurry box 2000 generally includes a structure 2010 that forms an interior to contain a cuttings slurry. In one embodiment, the structure 2010 may be manufactured of abrasion resistant steel armor plate such as AR400, AR500 or other such steel alloy. Such steel is a grade of abrasion resistant steel armor plate that offers significant wear and impact resistance with a hardness range between 477-550 BHN.

The structure 2010 may, for example, at least partially form a tank that defines the interior to contain the cuttings slurry that may be dumped in via a top surface located door 2012, and/or be drawn in under a vacuum as described above. Alternatively, or in addition, the structure 2010 can be an exoskeleton that protects a separate tank that can withstand a vacuum pressure. Alternatively, or in addition, the structure 2010 itself can withstand a vacuum pressure. In other words, the structure 2010 may at least partially contain a tank, protect a tank, form a box such as a dumpster itself that operates as a tank and/or be an integrated component of a structure and a tank. In various embodiments, the structure 2010, the tank, and the mechanical bay 2030 may be separate or integral components. For example, the structure itself may form the tank and the mechanical bay. The structure 2010 may be a rectilinear box in which the sides are welded with a tab and slot construction to, for example, increase the durability thereof.

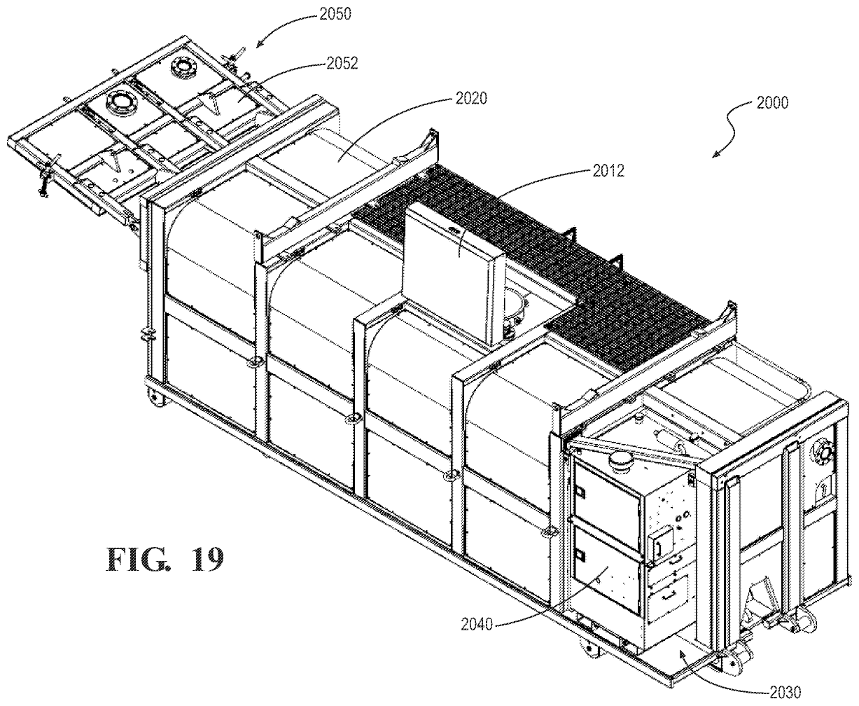

The structure 2010 may include the door 2012 located within a top surface 2020. The door 2012 may be movable between a closed position and an open position (FIG. 19) to provide access to the interior of the structure 2010 to contain materials such as the cutting slurry. The door 2012 in one embodiment may be located within the top surface 2020 of the transportable slurry box 2000. The door 2012 provides access to the interior for top loading dry product or cuttings slurry.

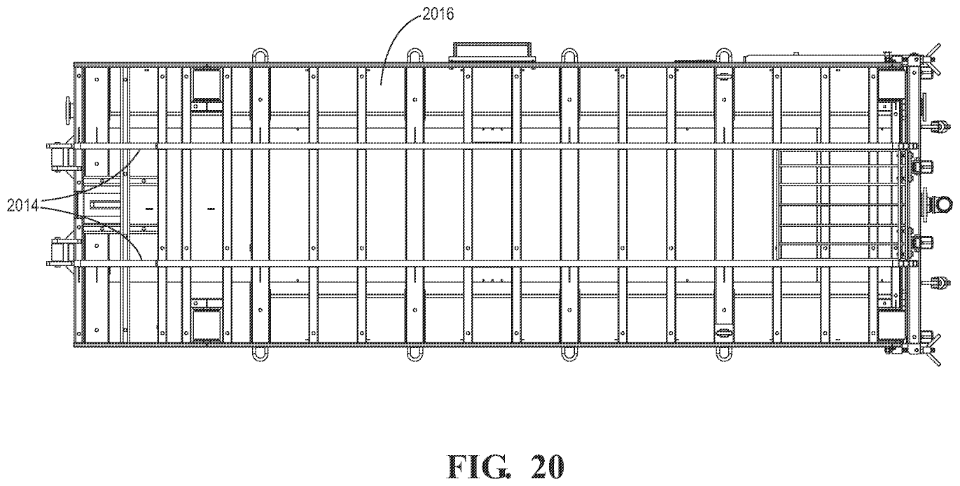

The structure 2010 may include one or more roll off rails 2014 (two shown) along at least a portion of a bottom 2016 (FIG. 20) thereof. The roll off rail 2014 may be formed as a hardened strip manufactured of abrasion resistant steel armor plate such as AR400, AR500 or other such steel alloy. That is, the roll off rail 2014 may be manufactured of the same or a different material than that of the structure 2010 to facilitate sliding along the vehicle when raised.

The transportable slurry box 2000 may further include a mechanical bay 2030. The mechanical bay 2030 may include equipment such a motive power source, heating fluid storage, electrical equipment, control equipment, etc., that facilitates operation of the transportable slurry box 2000 including, for example, heating and hydraulic operations. By locating such equipment in the mechanical bay 2030, the equipment may be removed when not required so as to minimize wear and tear on the equipment as discussed above.

For example, a heating unit 2040 is removably mounted within the mechanical bay 2030 for heating of the cuttings slurry when contained within the interior. The heating unit 2040 may be a fluid system as discussed above, an electrically powered heating unit, a rechargeable sodium battery powered system, and/or combinations thereof. Alternatively, no heating unit 2040 may be provided, or may be removed from the mechanical bay 2030, for example, during more temperate times of the year. Removal of the heating unit 2040 minimizes wear and tear when heating of the cutting slurry is not required.

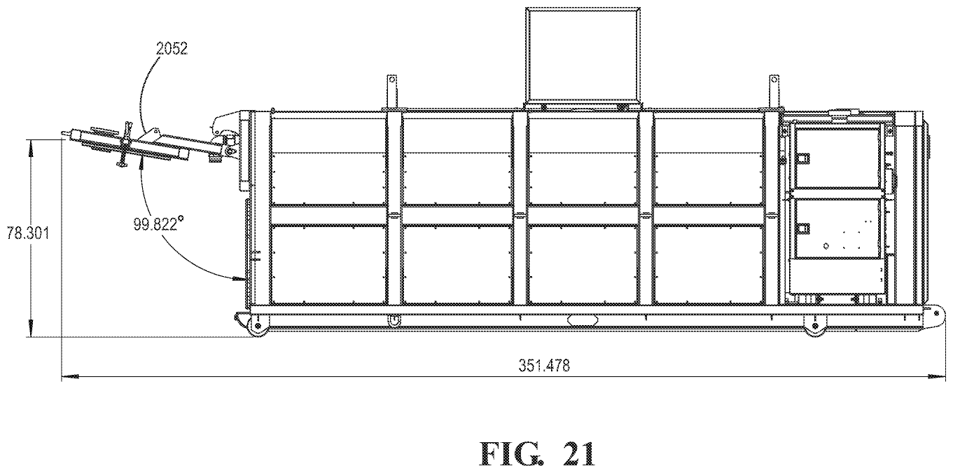

The transportable slurry box 2000 may further include a tailgate assembly 2050 at one end thereof. The tailgate assembly 2050, in this embodiment, includes a tailgate 2052 movable between an open position (also shown in FIGS. 19 and 21) in which the tailgate opens upward toward the top of the structure 2010 of the transportable slurry box 2000 and a closed position (also shown in FIGS. 18 and 20) which seals the interior of the structure 2010 of the transportable slurry box 2000. The open position (FIG. 21) of the tailgate 2052 may be greater than 90 degrees. In on embodiment, the open position (FIG. 21) may be almost 100 degrees relative to the position when fluidly sealed.

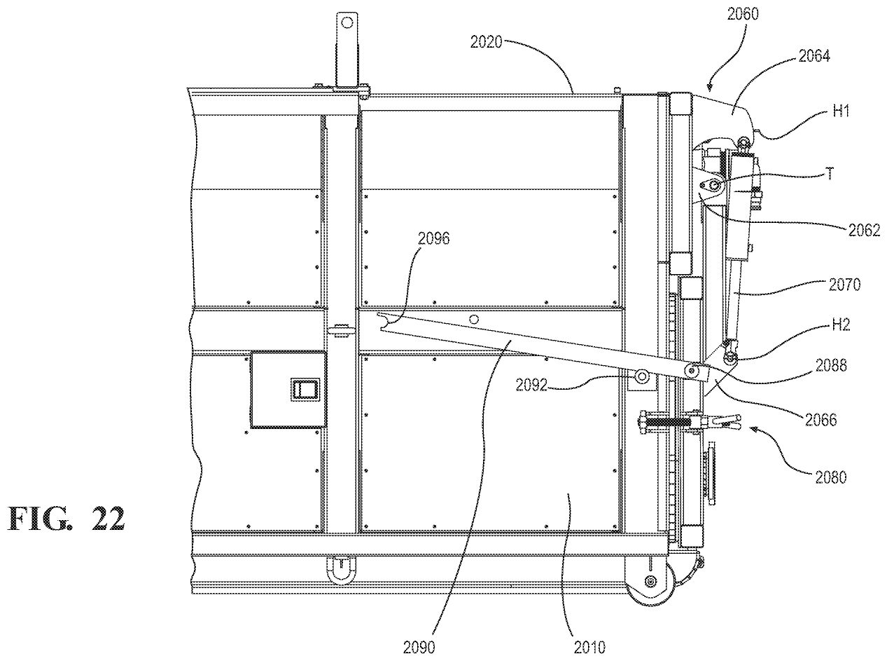

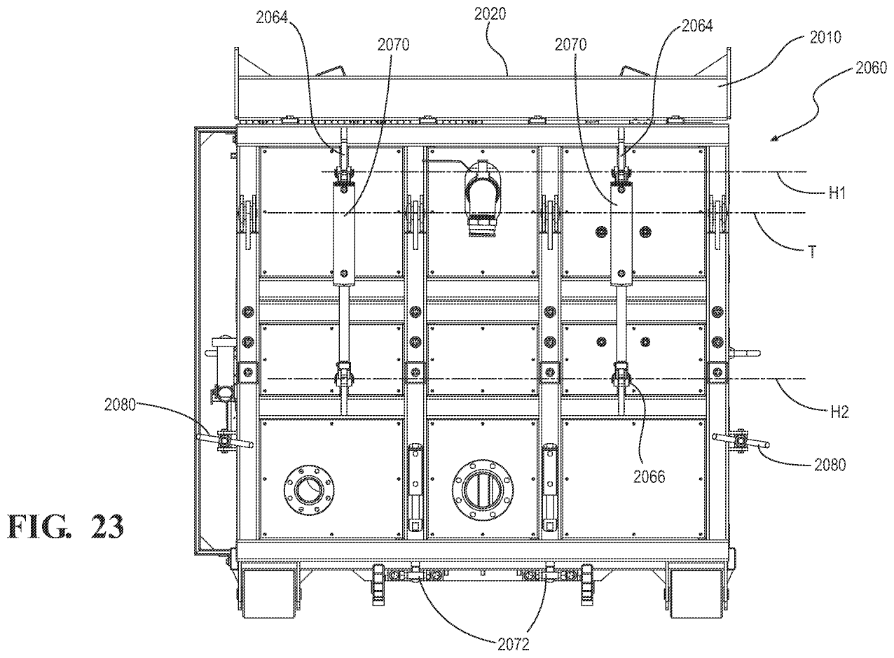

With reference to FIG. 22, the tailgate assembly 2050 includes a tailgate hinge assembly 2060 with a tailgate hinge 2062 that defines a tailgate hinge axis T parallel to the top surface 2020 (FIG. 23). Although a single tailgate hinge assembly 2060 will be described in detail, two (shown) or more tailgate hinge assemblies may be utilized with the tailgate assembly 2050.

A first hydraulic mount 2064 of the tailgate hinge assembly 2060 is affixed to the structure 2010 of the transportable slurry box 2000. The first hydraulic mount 2064 defines a first hydraulic mount axis H1 located vertically between the tailgate hinge axis T and the top surface 2020.

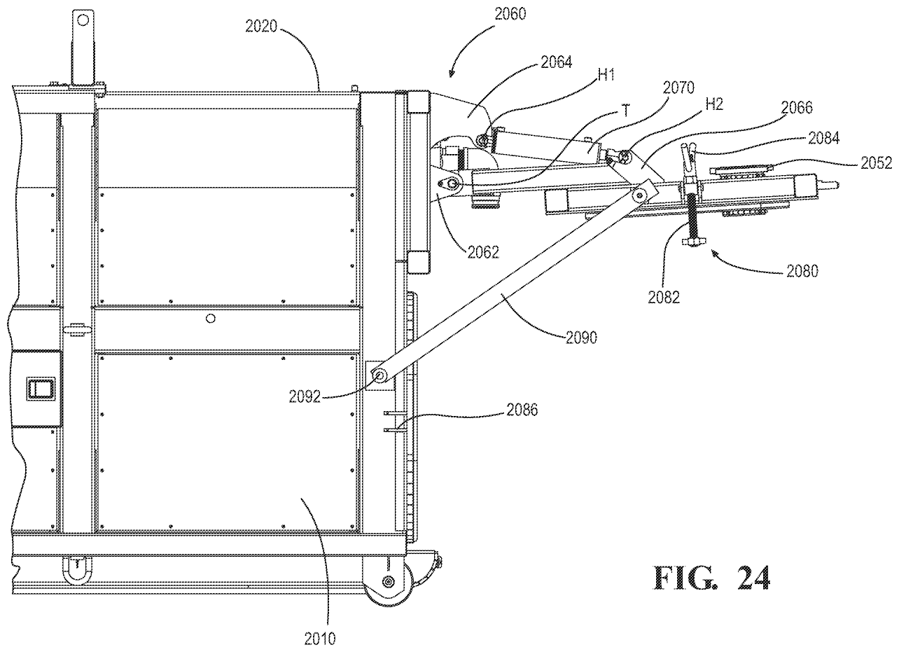

A second hydraulic mount 2066 of the tailgate hinge assembly 2060 is affixed to the tailgate 2052. The second hydraulic mount 2066 defines a second hydraulic mount axis H2 displaced from the tailgate 2052. That is, the first hydraulic mount 2064 and the second hydraulic mount 2066 may, for example include brackets that space the axes H1, H2 outboard with respect to a plane formed by the tailgate 2052 (best seen in FIG. 23 and FIG. 24.)

A hydraulic actuator cylinder 2070 is mounted to the first hydraulic mount 2064 and the second hydraulic mount 2066. The hydraulic actuator cylinder 2070 extends transverse to the tailgate hinge axis T (FIG. 23). The first hydraulic mount axis H1 is displaced from the structure of the transportable slurry box a distance greater than that which the tailgate hinge axis T is displaced from the structure of the transportable slurry box 2000.

One or more hydraulic powered vertical latches 2072 adjacent to a bottom of the tailgate 2052 may be used to latch the tailgate in the closed position.

The hydraulic actuator cylinder 2070 provides the motive force to move the tailgate 2052 between the open position (also shown in FIGS. 19 and 21) and the closed position (also shown in FIGS. 18 and 20). The hydraulic actuator cylinder 2070 and the hydraulic powered vertical latches 2072 may be powered by a hydraulic pump driven by a power unit within the mechanical bay 2030. The hydraulic pump driven by the power unit may be operated in response to a control system that may be attached to the transportable slurry box 2000 such as within the mechanical bay 2030 and or to a control system that is remote and selectively connected. In use, the hydraulic powered vertical latches 2072 and the hydraulic actuator cylinder 2070 are operated in a predefined sequence to move the tailgate 2052 between the open position and the closed position.

To further secure the tailgate 2052 in addition to the hydraulic powered vertical latches 2072, one or more manual latches 2080 may be utilized. The manual latch 2080 in this embodiment includes a threaded bolt 2082 and a wingnut 2084 secured to a bracket 2086 when the tailgate 2052 is in the closed position. The wingnut 2084 in the example, is rotated manually by an operator once the threaded bolt 2082 is engaged with the bracket 2086.

To still further secure the tailgate 2052 in the open position such that the tailgate may not inadvertently close, a safety brace 2090 is hingedly attached to the tailgate 2052 at a hinge pin 2088 to automatically engage with a pin 2092 attached to the structure 2010. The safety brace 2090 is configured such that the tailgate may not close when the safety brace 2090 is positioned against the pin 2092. The safety brace 2090 may include an arcuate end 2096 that engages with the pin 2092 as the tailgate 2052 is moved to the open position. That is, as the tailgate 2052 moves toward the open position, the safety brace 2090 slide along the pin 2092 until engaged therewith. The safety brace 2090 must be manually disengaged with the pin 2092 prior to the tailgate 2052 being moved to the closed position.

Although the different non-limiting embodiments have specific illustrated components, the embodiments of this invention are not limited to those particular combinations. It is possible to use some of the components or features from any of the non-limiting embodiments in combination with features or components from any of the other non-limiting embodiments.

The foregoing description is exemplary rather than defined by the limitations within. Various non-limiting embodiments are disclosed herein, however, one of ordinary skill in the art would recognize that various modifications and variations in light of the above teachings will fall within the scope of the appended claims. It is therefore to be appreciated that within the scope of the appended claims, the disclosure may be practiced other than as specifically described. For that reason the appended claims should be studied to determine true scope and content.

What is claimed is:

1. A transportable slurry box, comprising:
a structure comprising an interior to contain a cuttings slurry;
a door movable between a closed position and an open position to provide access to the interior of the structure, wherein the door is located within a top surface of the transportable slurry box to receive the cuttings slurry;
a mechanical bay in the structure; and
a heating unit removably mounted within the mechanical bay of the transportable slurry box for heating the cuttings slurry within the interior.

2. The transportable slurry box as recited in claim 1, wherein the structure at least partially forms a tank that defines the interior to contain the cuttings slurry.

3. The transportable slurry box as recited in claim 2, wherein the structure is operable to withstand a vacuum pressure.

4. The transportable slurry box as recited in claim 1, further comprising:
a tailgate movable between an open position in which the tailgate opens upward toward a top of the transportable slurry box and a closed position which seals the transportable slurry box;
a tailgate hinge that defines a hinge axis parallel to the top of the transportable slurry box;
a first hydraulic mount affixed to the transportable slurry box, the hydraulic mount located between the hinge axis and the top of the transportable slurry box;
a second hydraulic mount affixed to the tailgate; and
a hydraulic actuator cylinder mounted to the first hydraulic mount and the second hydraulic mount, the hydraulic cylinder transverse the axis.

5. The transportable slurry box as recited in claim 4, further comprising:
a hydraulic pump driven by a power unit within the mechanical bay, the hydraulic pump contained in the mechanical bay, wherein the hydraulic pump produces flow and pressure to operate the hydraulic cylinder to move the tailgate between the open position and the closed position.

6. The transportable slurry box as recited in claim 5, wherein the heating unit is removably mounted within the mechanical bay of the transportable slurry box.

7. The transportable slurry box as recited in claim 1, wherein the heating unit includes a supply port and a return port, and wherein the heating unit is adapted to heat a fluid producing a heated fluid flow; and
a first heat loop fluidly connected to the supply port of the heating unit and the return port of the heating unit, wherein the first heat loop is attached to the interior, and wherein the first heat loop circulates the heated fluid flow to heat the interior, wherein the first heat loop comprises a first supply line fluidly connected to the supply port and a first return line fluidly connected to the return port, the first supply line and the first return line each have a straight structure that is parallel with respect to a longitudinal axis of the structure of the transportable slurry box.

8. The transportable slurry box as recited in claim 1, wherein the heating unit comprises an electrically powered heating unit and a sodium battery.

9. The transportable slurry box as recited in claim 1, further comprising a hook point on the structure to receive a wire break safety stop.

10. The transportable slurry box as recited in claim 1, further comprising a roll off rail hardened strip manufactured of abrasion resistant steel armor plate along at least a portion of a bottom of the structure.

11. A tailgate assembly for a transportable slurry box, comprising:
a tailgate movable between an open position in which the tailgate opens upward toward a top of a structure of the transportable slurry box and a closed position which seals the transportable slurry box;
a tailgate hinge that defines a hinge axis parallel to the top of the structure of the transportable slurry box;
a first hydraulic mount affixed to the structure of the transportable slurry box, the first hydraulic mount defines a first hydraulic mount axis located between the hinge axis and the top of the structure of the transportable slurry box;
a second hydraulic mount affixed to the tailgate, the second hydraulic mount defines a second hydraulic mount axis displaced from the tailgate; and
a hydraulic actuator cylinder mounted to the first hydraulic mount and the second hydraulic mount, the hydraulic cylinder transverse the hinge axis.

12. The tailgate assembly as recited in claim 11, wherein the first hydraulic mount axis is displaced from the structure of the transportable slurry box a distance greater than that which the hinge axis is displaced from the structure of the transportable slurry box.

13. The tailgate assembly as recited in claim 11, wherein the first hydraulic mount axis and the second hydraulic mount axis are parallel to the hinge axis.

14. The tailgate assembly as recited in claim 11, further comprising a hydraulic powered vertical latch adjacent to a bottom of the tailgate.

15. The tailgate assembly as recited in claim 11, further comprising a manual lock adjacent to a side of the tailgate.

16. The tailgate assembly as recited in claim 15, wherein the manual lock comprises a threaded fastener attached to the tailgate engageable with a bracket on the structure of the transportable slurry box.

17. The tailgate assembly as recited in claim 11, further comprising a safety brace hingedly attached to the tailgate, the safety brace configured such that the tailgate may not close when the safety brace is positioned against a pin that extends from the structure of the transportable slurry box.

18. The tailgate assembly as recited in claim 17, wherein the safety brace is hingedly attached to the tailgate adjacent to the second hydraulic mount affixed to the tailgate.

19. A transportable slurry box, comprising:
a structure comprising an interior to contain a cuttings slurry;
a door movable between a closed position and an open position to provide access to the interior of the structure, wherein the door is located within a top surface of the transportable slurry box to receive the cuttings slurry;
a tailgate movable between an open position in which the tailgate opens upward toward a top of a structure of the transportable slurry box and a closed position which seals the transportable slurry box;
a tailgate hinge that defines a hinge axis parallel to the top of the structure of the transportable slurry box;
a first hydraulic mount affixed to the structure of the transportable slurry box, the first hydraulic mount defines a first hydraulic mount axis located between the hinge axis and the top of the structure of the transportable slurry box;
a second hydraulic mount affixed to the tailgate, the second hydraulic mount defines a second hydraulic mount axis displaced from the tailgate; and
a hydraulic actuator cylinder mounted to the first hydraulic mount and the second hydraulic mount, the hydraulic cylinder transverse the hinge axis.

20. The transportable slurry box as recited in claim 19, further comprising:
a mechanical bay in the structure;
a hydraulic pump driven by a power unit within the mechanical bay of the transportable slurry box, the hydraulic pump contained in the mechanical bay, wherein the hydraulic pump produces flow and pressure to operate the hydraulic cylinder to move the tailgate between the open position and the closed position; and
a heating unit removably mounted within the mechanical bay of the transportable slurry box for heating the cuttings slurry within the interior.
